(19) United States
(12) Patent Application Publication
(10) Pub. No.: US 2006/0111931 A1
(43) Pub. Date: May 25, 2006

(54) Method for the use of and interaction with business system transfer functions

(75) Inventors: Christopher Donald Johnson, Clifton Park, NY (US); Onur Ilkin Dulgeroglu, Niskayuna, NY (US); Peter Arnold Kalish, Clifton Park, NY (US); Kunter Seref Akbay, Niskayuna, NY (US)

Correspondence Address: GENERAL ELECTRIC COMPANY;GLOBAL RESEARCH, PATENT DOCKET RM. BLDG. K1-4A59, NISKAYUNA, NY, 12309, US

(73) Assignee: General Electric Company

(21) Appl. No.: 11/321,828

(22) Filed: Dec. 29, 2005

Related U.S. Application Data
(63) Continuation-in-part of application No. 10/339,166, filed on Jan. 9, 2003.

(51) Int. Cl. G06Q 99/00; G05B 19/418; G06F 15/02; G07G 1/00

(52) U.S. Cl. 705/1; 705/8; 705/9; 705/10

(57) ABSTRACT

A method for using and interacting with mathematical or algorithmic business system transfer functions in support of a business information, analysis, decisioning and control system. The method includes developing at least one high-level business system view wherein the transfer function is configured to quantitatively express the business system view; identifying a number of input parameters associated with one or more of the resources used in the business process, identifying at least one output parameter associated with the operation of the business process; collecting operational data that associate the number of input parameters with the at least one output parameter based on an actual operation of the business process. The method also includes a primary display layer that presents a control scenario for a testbed environment for the business information and decisioning control system.

This application is a continuation-in-part of U.S. patent application Ser. No. 10/339,166, filed on Jan. 9, 2003, entitled “Digital Cockpit,” which is incorporated by reference herein in its entirety.

### TECHNICAL FIELD

This invention relates to derivation of business system transfer functions, and in a more particular implementation, to derivation of transfer functions having predictive capability for integration into a business intelligence system.

### BACKGROUND OF THE INVENTION

Managing the operation of a business, such as an industrial, financial service or healthcare business, in a way that fulfills the organization's mission requires information, decision-making and control of the business' processes. To assist decision-makers, it could be desirable to provide them with a qualitative description of the operation of their business processes. It would also be helpful to provide a view into how the business processes might behave in the future. This information and prediction can help the decision maker to manage and control the business effectively.

It is taken as a given that it is impossible to know for certain what the future holds and a variety of automated techniques exist for making business forecasts and decisions, including various business simulation and automation techniques. These have accuracy limitations and these techniques are often applied in a quantitatively unstructured manner. For instance, a business analyst may have a notion that the business might be mathematically described in a particular way or that computer-automated statistical forecasting tools might be of use in predicting certain aspects of business performance based on the relationships between the outputs and the inputs of the business. In this case, the business analyst proceeds by selecting tools, determining the data input requirements of the selected tool, manually collecting the required data from the business, and then performing a forecast using the tool to generate an output result. The business analyst then determines whether the output result warrants making changes to the business. If so, the business analyst attempts to determine what aspects of the business should be changed, and then proceeds to modify these aspects in manual fashion, e.g., by manually accessing and modifying a resource used by the business. If the result of these changes does not produce a satisfactory result, the business analyst may decide to make further corrective changes to the business.

There are many drawbacks associated with the above-described ad hoc approach. One problem with the approach is that it puts a tremendous emphasis on different combinations and quantities of the inputs to get the desired combinations and quantities of the output, neglecting most often to elicit an exact and quantified relationship between the input and the output parameters (the relationship in mathematical or algorithmic expressions is known as ‘transfer function’) in the first place. It is typically not possible to analyze future scenarios, make decision assumptions and then intervene with the business system dynamically using such an approach.

In traditional approaches, the transfer functions are most commonly developed using closed form analyses, numerical analyses, or experimentation. The numerical and experimental methods often use regression analysis and design of experiments. Closed form solutions are generally available for only relatively simple and stable problems. These transfer functions are typically obtained by brainstorming the relevant parameters and using regression analysis and design of experiments (DOE) to fit these parameters to the numerical analysis or experimental data. The resulting transfer functions are usually in polynomial forms. A drawback to this process is that polynomial transfer functions require relatively large DOE's since the known physical relationships are not used and instead are derived by observation. These resulting equations are cumbersome and often provide little insight into physical relationships among the input and the output parameters. Moreover, there is absence of any judgmental framework to discern between the important and the not-so-important input parameters for the purpose of selection for entry into the transfer functions. Similarly there is no judgmental framework to discern between the actionable and the non-actionable input parameters, nor a means to interact dynamically with both the analytical and business process infrastructure.

Moreover, traditional approaches are not well suited for automatic and real-time generation of transfer functions for quicker prediction of the output parameters of the business system. This is due, in part, to the fact that complex modeling algorithms may require a substantial amount of time to run using a computer. More specifically, performing a run may include the time-intensive tasks of collating data from historical databases and other sources, “scrubbing” the data to transform the data into a desired form, and performing various calculations. The processing is further compounded for those applications that involve performing several iterations of calculations (for example, for those applications that seek to construct a probability distribution of the input or the output parameters by repeating analyses multiple times). This means that the analyst typically waits several minutes, or perhaps even several hours, to receive the output result. This tends to tie up both human and computer resources in the business, and may be generally frustrating to the analyst.

There is therefore an exemplary need to provide a more efficient technique for deriving business system transfer functions and interacting with them.

### BRIEF DESCRIPTION OF THE INVENTION

According to one exemplary embodiment of the invention, a method is described for using mathematical or algorithmic business system transfer functions in support of a business information, analysis, decisioning and control system. The method includes developing at least one high-level business system view wherein the transfer function is configured to quantitatively express the business system view; identifying a number of input parameters associated with one or more of the resources used in the business process, identifying at least one output parameter associated with the operation of the business process; collecting operational data that associate the number of input parameters with the at least one output parameter based on an actual operation of the business process. The method also includes determining at least one relationship between the at least one output parameter and the number of input parameters based on the operational data and mathematically or algorithmically describing the at least one relationship between the at least one output parameter and the number of input parameters using the at least one transfer function. The method further includes displaying particular values of at least one of the number of input parameters, at least one output parameter or at least one transfer function. The step of displaying includes constructing and displaying a stochastic simulation of at least one output parameter based on at least one transfer function using a primary display layer that presents a testbed environment for the business information and decisioning control system; interpreting at least one of signals, trends, warning and conclusions generated by the stochastic simulation and presenting an interpretation of at least one of signals, trends, warning and conclusions generated by the stochastic simulation using at least one secondary display layer; and displaying a number of suggested business decisions using a tertiary display layer, wherein the number of suggested business decisions developed based on the signals, trends, warning and conclusions generated by the primary display layer and the interpretation presented by at least one secondary display layer.

In accordance with another embodiment of the invention, a business system user interface of a business information and decisioning control system is described, wherein the business information and decisioning control system includes a control module that is configured to receive information provided by multiple interrelated business processes in a business in relation to a number of input parameters associated with one or more of the resources used in the business and at least one output parameter associated with the operation of the business process and configured to generate a number of mathematical or algorithmic business system transfer functions. The business system user interface includes a primary display layer that presents a testbed environment for the business information and decisioning control system. The primary display layer is constructed as a stochastic simulation of the at least one output parameter based on the number of mathematical or algorithmic business system transfer functions. The business system user interface also includes at least one secondary display layer that presents interpretation of at least one of signals, trends, warning and conclusions generated by the primary display layer. The business system user interface further includes a tertiary display layer that presents a number of suggested business decisions developed based on the signals, trends, warnings and conclusions generated by the primary display layer and the interpretation presented by at least one secondary display layer.

In accordance with another embodiment of the invention, a business system framework, including multiple interrelated business processes is described for accomplishing a business objective. The interrelated business processes each includes a number of resources that collectively perform a business task; a business information and decisioning control system, that includes a number of mathematical or algorithmic business system transfer functions in support of the business information and decisioning control system; a control module configured to receive information provided by the multiple interrelated business processes in relation to a number of input parameters associated with the number of resources and at least one output parameter associated with the operation of the business process and configured to generate a number of mathematical or algorithmic business system transfer functions; a business system user interface, coupled to the control module, configured to allow a user to interact with the control module, the business system user interface including plural input mechanisms for receiving instructions from the user; wherein the control module includes logic configured to generate the number of transfer functions using a business model; logic configured to store the set of transfer functions; a storage for storing the transfer functions; logic configured to receive a user's request for an output result and logic configured to present the output result to the requesting user.

### BRIEF DESCRIPTION OF THE DRAWINGS

The above mentioned and other features will now be described with reference to the drawings of various embodiments of the business system decisioning framework. The drawings are intended to illustrate, but not to limit the invention. The drawings contain the following figures:

FIG. 1 shows an exemplary high-level view of an environment in which a business is using a “digital cockpit” to steer it in a desired direction.

FIG. 2 shows an exemplary system for implementing the digital cockpit shown in FIG. 1.

FIG. 3 shows an exemplary cockpit interface.

FIG. 4 shows an exemplary method for using the digital cockpit.

FIG. 5 shows an exemplary method for derivation of business system transfer functions for the digital cockpit shown in FIG. 1.

FIG. 6 shows an exemplary response surface for displaying a transfer function derived using method of FIG. 5 and for the digital cockpit shown in FIG. 1.

FIG. 7 shows another exemplary response surface to display using changes in perspective the uncertainty associated with a transfer function derived using method of FIG. 5 and for the digital cockpit shown in FIG. 1.

FIG. 8 shows an exemplary primary display layer of a user interface that presents a testbed simulation of a transfer function.

FIG. 9 shows another exemplary display layer of a user interface that presents a visual cockpit for interacting with the testbed simulation of FIG. 8 and its various interactive components.

FIG. 10 shows an exemplary view of the user interface with an inactive state of the display layer of FIG. 9 containing the visual cockpit superimposed on an active state of the primary display layer of FIG. 8 containing the testbed simulation.

FIG. 11 shows an exemplary view of the user interface with a partially active state of the display layer of FIG. 9 containing the visual cockpit superimposed on a partially active state of the primary display layer of FIG. 8 containing the testbed simulation.

### DETAILED DESCRIPTION

This disclosure pertains to a technique for working with a transfer function that quantifies a relationship between input and output parameters of a business system. Techniques for integrating that transfer function into a business intelligence system that includes human interactivity in a prospective manner are also described. By way of introduction, a business intelligence system generally refers to any kind of infrastructure for providing business analysis within a business. In the context of this business intelligence system, a decisioning control system that provides business forecasts is also described. The system is used to control a business that includes multiple interrelated processes. As used herein, a “business” may refer broadly to any enterprise for providing goods or services, whether for profit or used to achieve some other measured performance goal. Businesses may be a single entity, or a conglomerate entity that includes several different business groups or companies within the conglomerate.

To facilitate explanation, the business information and decisioning control system is referred to in the ensuing discussion by the descriptive phrase “digital cockpit.” A business intelligence interface of the digital cockpit will be referenced to as a “cockpit interface.”

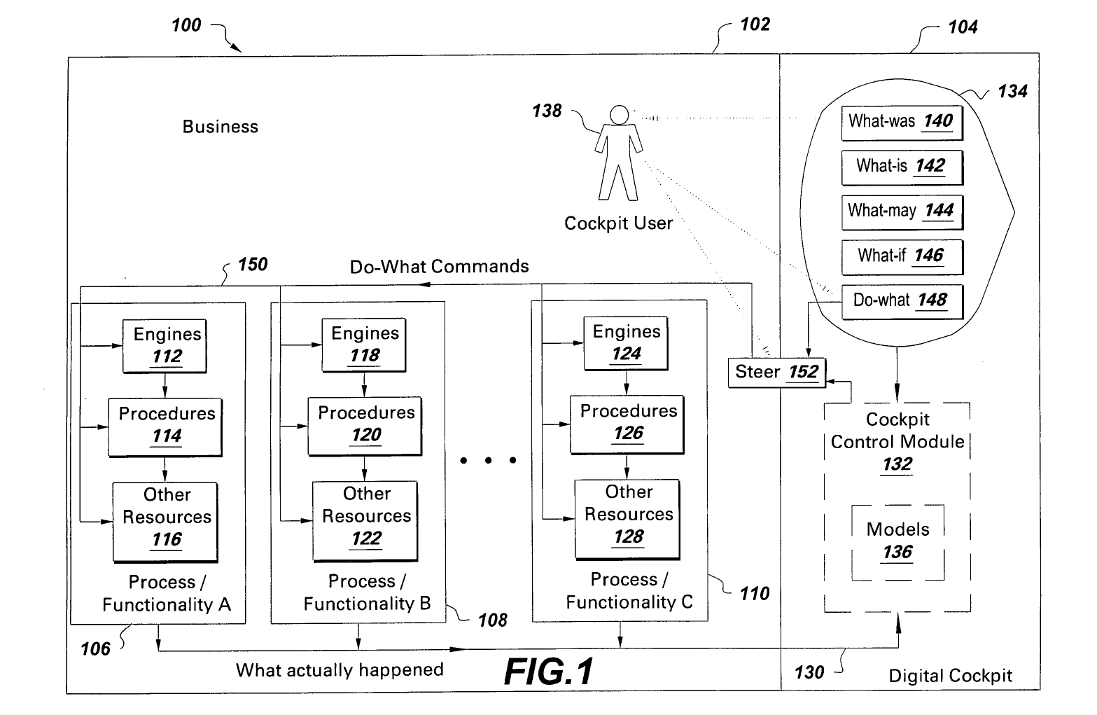

FIG. 1 shows a high-level view of an environment 100 in which a business 102 is using a digital cockpit 104 to steer it in a desired direction. The business 102 is generically shown as including an interrelated series of processes (106, 108, . . . 110). The processes (106, 108, . . . 110) respectively perform allocated functions within the business 102. That is, each of the processes (106, 108, . . . 110) receives one or more input items, perform processing on the input items, and then output the processed items. For instance, in a manufacturing environment, the processes (106, 108, . . . 110) may represent different stages in an assembly line for transforming raw material into a final product. Other exemplary processes in the manufacturing environment can include shop scheduling, machining, design work, etc. In a finance-related business 102, the processes (106, 108, . . . 110) may represent different processing steps used in transforming a business lead into a finalized transaction that confers some value to the business 102. Other exemplary processes in this environment can include pricing, underwriting, asset management, etc. Many other arrangements are possible. As such, the input and output items fed into and out of the processes (106, 108, . . . 110) can represent a wide variety of “goods,” including human resources, information, capital, physical material, and so on. In general, the business processes (106, 108, . . . 110) may exist within a single business entity 102. Alternatively, one or more of the processes (106, 108, . . . 110) can extend to other entities, markets, and value chains (such as suppliers, distribution conduits, commercial conduits, associations, and providers of relevant information).

More specifically, each of the processes (106, 108, . . . 110) can include a collection of resources. The term “resources” as used herein has broad connotation and can include any aspect of the process that allows it to transform input items into output items. For instance, process 106 may draw from one or more engines 112. An “engine” 112 refers to any type of tool used by the process 106 in performing the allocated function of the process 106. In the context of a manufacturing environment, an engine 112 might refer to a machine for transforming materials from an initial state to a processed state. In the context of a finance-related environment, an engine 112 might refer to a technique for transforming input information into processed output information. For instance, in one finance-related application, an engine 112 may include one or more equations for transforming input information into output information. In other applications, an engine 112 may include various statistical techniques, rule-based techniques and artificial intelligence techniques. A subset of the engines 112 can be used to generate decisions at decision points within a business flow. These engines are referred to as “decision engines.” The decision engines can be implemented using manual analysis performed by human analysts, automated analysis performed by automated computerized routines, or a combination of manual and automated analysis. Rather than a decision engine, human intervention is also possible.

Other resources in the process 106 include various procedures 114. In one implementation, the procedures 114 represent general protocols followed by the business in transforming input items into output items. In another implementation, the procedures 114 can reflect automated protocols for performing this transformation.

The process 106 may also generically include “other resources” 116. Such other resources 116 can include any feature of the process 106 that has a role in carrying out the function(s) of the process 106. An exemplary “other resource” may include staffing resources. Staffing resources refer to the personnel used by the business 102 to perform the functions associated with the process 106. For instance, in a manufacturing environment, the staffing resources might refer to the workers required to run the machines within the process. In a finance-related environment, the staffing resources might refer to personnel required to perform various tasks involved in transforming information or “financial products” (e.g., contracts) from an initial state to a final processed state. Such individuals may include salesman, accountants, actuaries, etc. Still other resources can include various control platforms (such as Supply Chain, Enterprise Resource Planning, Manufacturing-Requisitioning and Planning platforms, etc.), technical infrastructure, etc.

In like fashion, process 108 includes one or more engines 118, procedures 120, and other resources 122. Process 110 includes one or more engines 124, procedures 126, and other resources 128. Although the business 102 is shown as including three processes (106, 108, . . . 110), this is merely exemplary; depending on the particular business environment, more than three processes can be included, or less than three processes can be included.

The digital cockpit 104 collects information received from the processes (106, 108, . . . 110) via communication path 130, and then processes this information. Such communication path 130 may represent a digital network communication path, such as the Internet, an Intranet network within the business enterprise 102, a LAN network, etc. The digital cockpit 104 also includes a cockpit control module 132 coupled to a cockpit interface 134. The cockpit control module 132 includes one or more models 136. A model 136 transforms information collected by the processes (106, 108, . . . 110) into an output using a transfer function or plural transfer functions. Mathematical or algorithmic description of transfer function will be presented in greater details below.

Other functionality provided by the cockpit control module 132 can perform data collection tasks. Such functionality specifies the manner in which information is to be extracted from one or more information sources and subsequently transformed into a desired form. The information can be transformed by algorithmically processing the information using one or more models 136, or by manipulating the information using other techniques. More specifically, such functionality is generally implemented using so-called Extract-Transform-Load tools (i.e., ETL tools).

A subset of the models 136 in the cockpit control module 132 may be the same as some of the models embedded in engines (112, 118, 124) used in respective processes (106, 108, . . . 110). In this case, the same transfer functions used in the cockpit control module 132 can be used in the day-to-day business operations within the processes (106, 108, . . . 110). Other models 136 used in the cockpit control module 132 are exclusive to the digital cockpit 104 (e.g., having no counterparts within the processes themselves (106, 108, . . . 110)). In the case where the cockpit control module 132 uses the same models 136 as one of the processes (106, 108, . . . 110), it is possible to store and utilize a single rendition of these models 136, or redundant copies or versions of these models 136 can be stored in both the cockpit control module 132 and the processes (106, 108, . . . 110).

A cockpit user 138 interacts with the digital cockpit 104 via the cockpit interface 134. The cockpit user 138 can include any individual within the business 102 (or potentially outside the business 102). The cockpit user 138 frequently will have a decision-maker role within the organization, such as chief executive officer, risk assessment analyst, general manager, an individual intimately familiar with one or more business processes (e.g., a business “process owner”), and so on.

The cockpit interface 134 presents various fields of information regarding the course of the business 102 to the cockpit user 138 based on the outputs provided by the models 136. For instance, the cockpit interface 134 may include a field 140 for presenting information regarding the past course of the business 102 (referred to as a “what has happened” field, or a “what-was” field for brevity). The cockpit interface 134 may include another field 142 for presenting information regarding the present state of the business 102 (referred to as “what is happening” field, or a “what-is” field for brevity). The cockpit interface 134 may also include another field 144 for presenting information regarding the projected future course of the business 102 (referred to as a “what may happen” field, or “what-may” field for brevity).

In addition, the cockpit interface 134 presents another field 146 for receiving hypothetical case assumptions from the cockpit user 138 (referred to as a “what-if” field). More specifically, the “what-if” field 146 allows the cockpit user 138 to enter information into the cockpit interface 134 regarding hypothetical or actual conditions within the business 102. The digital cockpit 104 will then compute various consequences of the identified conditions within the business 102 and present the results to the cockpit user 138 for viewing in the “what-if” display field 146.

After analyzing information presented by fields 140, 142, 144, and 146, the cockpit user 138 may be prepared to take some action within the business 102 to steer the business 102 in a desired direction based on some objective in mind (e.g., to increase revenue, increase sales volume, improve processing timeliness, etc.). To this end, the cockpit interface 134 includes another field (or fields) 148 for allowing the cockpit user 138 to enter commands that specify what the business 102 is to do in response to information (referred to as “do-what” commands for brevity).

The “do-what” commands can affect a variety of changes within the processes (106, 108, . . . 110) of FIG. 1 depending on the particular business environment in which the digital cockpit 104 is deployed. In one case, the “do-what” commands affect a change in the engines (112, 118, 124) used in the respective processes (106, 108, . . . 110). Such modifications may include changing parameters used by the engines (112, 118, 124), changing the strategies used by the engines (112, 118, 124), changing the input data fed to the engines (112, 118, 124), or changing any other aspect of the engines (112, 118, 124). In another case, the “do-what” commands affect a change in the procedures (114, 120, 126) used by the respective processes (106, 108, 110). Such modifications may include changing the number of workers assigned to specific tasks within the processes (106, 108, . . . 110), changing the amount of time spent by the workers on specific tasks in the processes (106, 108, . . . 110), changing the nature of tasks assigned to the workers, or changing any other aspect of the procedures (114, 120, 126) used in the processes (106, 108, . . . 110). Finally, the “do-what” commands can generically make other changes to the other resources (116, 122, 128), depending on the context of the specific business application.

The business 102 provides other mechanisms for affecting changes in the processes (106, 108, . . . 110) besides the “do-what” field 148. Namely, in one implementation, the cockpit user 138 can directly make changes to the processes (106, 108, . . . 110) without transmitting instructions through the communication path 150 via the “do-what” field 148. In this case, the cockpit user 138 can directly visit and make changes to the engines (112, 118, 124) in the respective processes (106, 108, . . . 110). Alternatively, the cockpit user 138 can verbally instruct various staff personnel involved in the processes (106, 108, . . . 110) to make specified changes.

Whatever mechanism is used to affect changes within the business 102, such changes can also include modifications to the digital cockpit 104 itself. For instance, the cockpit user 138 can also make changes to the models 136 used in the cockpit control module 132. Such changes may comprise changing the parameters of a model 136, or entirely replacing one model 136 with another model 136, or supplementing the existing models 136 with additional models 136. Moreover, the use of the digital cockpit 104 may comprise an integral part of the operation of different business processes (106, 108, . . . 110). In this case, cockpit user 138 may want to change the models 136 in order to affect a change in the processes (106, 108, 110).

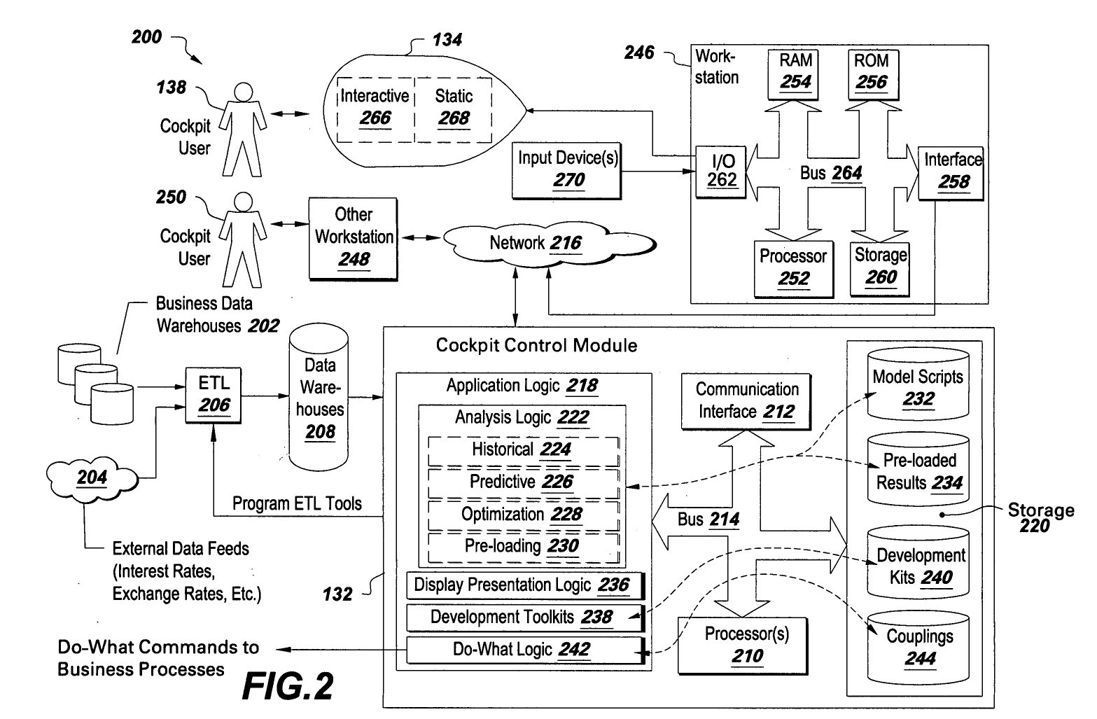

FIG. 2 shows an exemplary architecture 200 for implementing the functionality described in FIG. 1. The digital cockpit 104 receives information from a number of sources both within and external to the business 102. For instance, the digital cockpit 104 receives data from business data warehouses 202. These business data warehouses 202 store information collected from the business 102 in the normal course of business operations. In the context of the FIG. 1 depiction, the business data warehouses 202 can store information collected in the course of performing the tasks in processes (106, 108, . . . 110). Such business data warehouses 202 can be located together at one site, or distributed over multiple sites. The digital cockpit 104 also receives information from one or more external sources 204. Such external sources 204 may represent third party repositories of business information, such as enterprise resource planning sources, information obtained from partners in a supply chain, market reporting sources, etc.

An Extract-Transform-Load (ETL) module 206 extracts information from the business data warehouses 202 and the external sources 204, and performs various transformation operations on such information. The transformation operations can include: 1) performing quality assurance on the extracted data to ensure adherence to pre-defined guidelines, such as various expectations pertaining to the range of data, the validity of data, the internal consistency of data, etc; 2) performing data mapping and transformation, such as mapping identical fields that are defined differently in separate data sources, eliminating duplicates, validating cross-data source consistency, providing data convergence (such as merging records for the same customer from two different data sources), and performing data aggregation and summarization; 3) performing post-transformation quality assurance to ensure that the transformation process does not introduce errors, and to ensure that data convergence operations did not introduce anomalies, etc. The ETL module 206 also loads the collected and transformed data into a data warehouse 208. The ETL module 206 can include one or more selectable tools for performing its ascribed tasks, collectively forming an ETL toolset. For instance, the ETL toolset can include one of the tools provided by Informatica Corporation of Redwood City, Calif., and/or one of the tools provided by DataJunction Corporation of Austin, Tex. Still other tools can be used in the ETL toolset, including tools specifically tailored by the business 102 to perform unique in-house functions.

The data warehouse 208 may represent one or more storage devices. If multiple storage devices are used, these storage devices can be located in one central location or distributed over plural sites. Generally, the data warehouse 208 captures, scrubs, summarizes, and retains the transactional and historical detail used to monitor changing conditions and events within the business 102. Various known commercial products can be used to implement the data warehouse 208, such as various data storage solutions provided by the Oracle Corporation of Redwood Shores, Calif.

Although not shown in FIG. 2, the architecture 200 can include other kinds of storage devices and strategies. For instance, the architecture 200 can include an On-Line Analytical Processing (OLAP) server (not shown). An OLAP server provides an engine that is specifically tailored to perform data manipulation of multi-dimensional data structures. Such multi-dimensional data structures arrange data according to various informational categories (dimensions), such as time, geography, credit score, etc. The dimensions serve as indices for retrieving information from a multi-dimensional array of information, such as so-called OLAP cubes.

The architecture 200 can also include a digital cockpit data mart (not shown) that culls a specific set of information from the data warehouse 208 for use in performing a specific subset of tasks within the business enterprise 102. For instance, the information provided in the data warehouse 208 may serve as a global resource for the entire business enterprise 102. The information culled from this data warehouse 208 and stored in the data mart (not shown) may correspond to the specific needs of a particular group or sector within the business enterprise 102.

The information collected and stored in the above-described manner is fed into the cockpit control module 132. The cockpit control module 132 can be implemented as any kind of computer device, including one or more processors 210, various memory media (such as RAM, ROM, disc storage, etc.), a communication interface 212 for communicating with an external entity, a bus 214 for communicatively coupling system components together, as well as other computer architecture features that are known in the art. In one implementation, the cockpit control module 132 can be implemented as a computer server coupled to a network 216 via the communication interface 212. In this case, any kind of server platform can be used, such as server functionality provided by iPlanet, produced by Sun Microsystems, Inc., of Santa Clara, Calif. The network 216 can comprise any kind of communication network, such as the Internet, a business Intranet, a LAN network, an Ethernet connection, etc. The network 216 can be physically implemented as hardwired links, wireless links (e.g., radio frequency links), a combination of hardwired and wireless links, or some other architecture. It can use digital communication links, analog communication links, or a combination of digital and analog communication links.

The memory media within the cockpit control module 132 can be used to store application logic 218 and record storage 220. For instance, the application logic 218 can constitute different modules of program instructions stored in RAM memory. The record storage 220 can constitute different databases for storing different groups of records using appropriate data structures. More specifically, the application logic 218 includes analysis logic 222 for performing different kinds of analytical tasks. For example, the analysis logic 222 includes historical analysis logic 224 for processing and summarizing historical information collected from the business 102, and/or for presenting information pertaining to the current status of the business 102. The analysis logic 222 also includes predictive analysis logic 226 for generating business forecasts based on historical information collected from the business 102. Such predictions can take the form of extrapolating the past course of the business 102 into the future, and for generating error information indicating the degrees of confidence associated with its predictions. Such predictions can also take the form of generating predictions in response to an input “what-if” scenario. A “what-if” scenario refers to a hypothetical set of conditions (e.g., cases) that could be present in the business 102. Thus, the predictive logic 226 would generate a prediction that provides a forecast of what might happen if such conditions (e.g., cases) are realized through active manipulation of the business processes (106, 108, . . . 110).

The analysis logic 222 further includes optimization logic 228. The optimization logic 228 computes a collection of model results for different input case assumptions, and then selects a set of input case assumptions that provides preferred model results. More specifically, this task can be performed by methodically varying different variables defining the input case assumptions and comparing the model output with respect to a predefined goal (such as an optimized revenue value, or optimized sales volume, etc.). Such optimization may be performed automatically by computer optimization routines, manually with computer assistance (such as having the computer suggest alternative cases to test) or manually without computer assistance. The case assumptions that provide the “best” model results with respect to the predefined goal are selected, and then these case assumptions can be actually applied to the business processes (106, 108, . . . 110) to realize the predicted “best” model results in actual business practice.

Further, the analysis logic 222 also includes pre-loading logic 230 for performing data analysis in off-line fashion. More specifically, processing cases using the models 136 may be time-intensive. Thus, a delay may be present when a user requests a particular analysis to be performed in real-time fashion. To reduce this delay, the pre-loading logic 230 performs analysis in advance of a user's request. The pre-loading logic 230 can perform this task based on various considerations, such as an assessment of the variation in the response surface of the model 136, an assessment of the likelihood that a user will require specific analyses, etc.

The storage logic 220 can include a database 232 that stores various models scripts. Such models scripts provide instructions for running one or more analytical tools in the analysis logic 222. As used in this disclosure, a model 136 refers to an integration of the tools provided in the analysis logic 222 with the model scripts provided in the database 232. In general, such tools and scripts can execute regression analysis, time-series computations, cluster analysis, and other types of analyses. A variety of commercially available software products can be used to implement the above-described modeling tasks. To name but a small sample, the analysis logic 222 can use one or more of the family of Crystal Ball products produced by Decisioneering, Inc. of Denver Colo., one or more of the Mathematica products produced by Wolfram, Inc. of Champaign Ill., one or more of the SAS products produced by SAS Institute Inc. of Cary, N.C., etc.

The storage logic 220 can also include a database 234 for storing the results pre-calculated by the pre-loading logic 230. As mentioned, the digital cockpit 104 can retrieve results from this database when the user requests these results, instead of calculating these results at the time of request. This reduces the time delay associated with the presentation of output results, and supports the high-level aim of the digital cockpit 104, which is to provide timely and accurate results to the cockpit user 138 when the cockpit user 138 requests such results. The database 234 can also store the results of previous analyses performed by the digital cockpit 104, so that if these results are requested again, the digital cockpit 104 need not recalculate these results.

The application logic 218 also includes other programs, such as display presentation logic 236. The display presentation logic 236 performs various tasks associated with displaying the output results of the analyses performed by the analysis logic 222. Such display presentation tasks can include presenting probability information that conveys the confidence associated with the output results using different display formats. The display presentation logic 236 can also include functionality for rotating and scaling a displayed response surface to allow the cockpit user 138 to view the response surface from different “vantage points,” to thereby gain better insight into the characteristics of the response surface. Additional information regarding exemplary functions performed by the display presentation logic 236 will be provided later.

The application logic 218 also includes development toolkits 238. A first kind of development toolkit 238 provides a guideline used to develop a digital cockpit 104 with predictive capabilities. More specifically, a business 102 can comprise several different affiliated companies, divisions, branches, etc. A digital cockpit 104 may be developed in for one part of the company, and thereafter tailored to suit other parts of the company. The first kind of development toolkit 238 provides a structured set of consideration that a development team should address when developing the digital cockpit 104 for other parts of the company (or potentially, for another unaffiliated company). The first kind of development toolkit 238 may specifically include logic for providing a general “roadmap” for developing the digital cockpit 104 using a series of structured stages, each stage including a series of well-defined action steps. Further, the first kind of development toolkit 238 may also provide logic for presenting a number of tools that are used in performing individual action steps within the roadmap. U.S. patent application Ser. No. 10/418,428 (Attorney Docket No. 85CI-00128), filed on 18 Apr. 2003 and entitled, “Development of a Model for Integration into a Business Intelligence System,” provides additional information regarding the first kind of development toolkit 238. A second kind of development toolkit 238 can be used to derive the transfer functions used in the predictive digital cockpit 104. This second kind of development toolkit 238 can also include logic for providing a general roadmap for deriving the transfer functions, specifying a series of stages, where each stage includes a defined series of action steps, as well as a series of tools for use at different junctures in the roadmap. Record storage 220 includes a database 240 for storing information used in conjunction with the development toolkits 238, such as various roadmaps, tools, interface page layouts, etc.

Finally, the application logic 218 includes “do-what” logic 242. The “do-what” logic 242 includes the program logic used to develop and/or propagate instructions into the business 102 for affecting changes in the business 102. For instance, as described in connection with FIG. 1, such changes can constitute changes to engines (112, 118, 124) used in business processes (106, 108, . . . 110), changes to procedures (114, 120, 126) used in business processes (106, 108, . . . 110), or other changes. The “do-what” instructions propagated into the processes (106, 108, . . . 110) can also take the form of various alarms and notifications transmitted to appropriate personnel associated with the processes (106, 108, . . . 110) (e.g., transmitted via e-mail, or other communication technique).

In one implementation, the “do-what” logic 242 is used to receive “do-what” commands entered by the cockpit user 138 via the cockpit interface 134. Such cockpit interface 134 can include various graphical knobs, slide bars, switches, etc. for receiving the user's commands. In another implementation, the “do-what” logic 242 is used to automatically generate the “do-what” commands in response to an analysis of data received from the business processes (106, 108, . . . 110). In either case, the “do-what” logic 242 can rely on a coupling database 244 in developing specific instructions for propagation throughout the business 102. For instance, the “do-what” logic 242 in conjunction with the database 244 can map various entered “do-what” commands into corresponding instructions for affecting specific changes in the resources of business processes (106, 108, . . . 110).

The mapping described above can rely on rule-based logic. For instance, an exemplary rule might specify: “If a user enters instruction X, then affect change Y to engine resource 112 of process 106, and affect change Z to procedure 120 of process 108.” Such rules can be stored in the couplings database 244, and this information may effectively reflect empirical knowledge garnered from the business processes (106, 108, . . . 110) over time (e.g., in response to observed causal relationships between changes made within a business 102 and their respective effects). Effectively, then, this coupling database 244 constitutes the “control coupling” between the digital cockpit 104 and the business processes (106, 108, . . . 110), which it controls in a manner analogous to the control coupling between a control module of a physical system and the subsystems, which it controls. In other implementations, still more complex strategies can be used to provide control of the business 102, such as artificial intelligence systems (e.g., expert systems) for translating a cockpit user 138's commands to the instructions appropriate to affect such instructions.

The cockpit user 138 can receive information provided by the cockpit control module 132 using different devices or different media. FIG. 2 shows the use of computer workstations 246 and 248 for presenting cockpit information to cockpit users 138 and 250, respectively. However, the cockpit control module 132 can be configured to provide cockpit information to users using laptop computing devices, personal digital assistant (PDA) devices, cellular telephones, printed media, or other technique or device for information dissemination (none of which are shown in FIG. 2).

The exemplary workstation 246 includes conventional computer hardware, including a processor 252, RAM 254, ROM 256, a communication interface 258 for interacting with a remote entity (such as network 216), storage 260 (e.g., an optical and/or hard disc), and an input/output interface 262 for interacting with various input devices and output devices. These components are coupled together using bus 264. An exemplary output device includes the cockpit interface 134. The cockpit interface 134 can present an interactive display 266, which permits the cockpit user 138 to control various aspects of the information presented on the cockpit interface 134. Cockpit interface 134 can also present a static display 268, which does not permit the cockpit user 138 to control the information presented on the cockpit interface 134. The application logic for implementing the interactive display 266 and the static display 268 can be provided in the memory storage of the workstation 246 (e.g., the RAM 254, ROM 256, or storage 260, etc.), or can be provided by a computing resource coupled to the workstation 246 via the network 216, such as display presentation logic 236 provided in the cockpit control module 132.

Finally, an input device 270 permits the cockpit user 138 to interact with the workstation 246 based on information displayed on the cockpit interface 134. The input device 270 can include a keyboard, a mouse device, a joy stick, a data glove input mechanism, throttle input mechanism, track ball input mechanism, a voice recognition input mechanism, a graphical touch-screen display field, various kinds of biometric input devices, various kinds of biofeedback input devices, etc., or any combination of these devices.

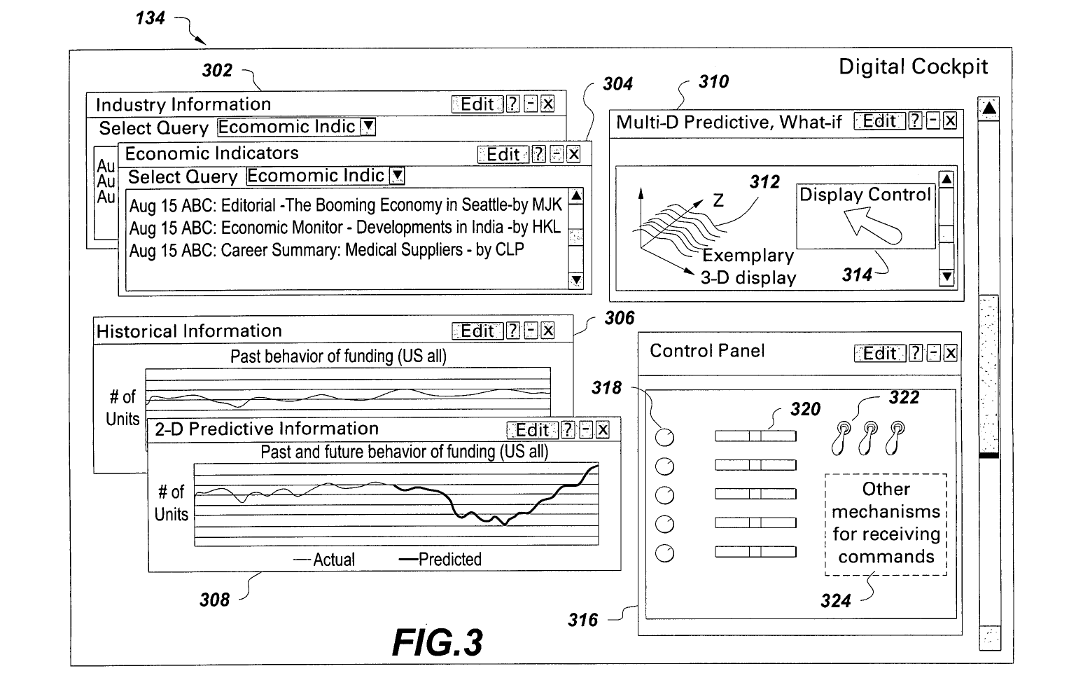

FIG. 3 provides an exemplary cockpit interface 134 for one business environment. The interface can include a collection of windows (or more generally, display fields) for presenting information regarding the past, present, and future course of the business 102, as well as other information. For example, windows 302 and 304 present information regarding the current business climate (i.e., environment) in which the business 102 operates. That is, for instance, window 302 presents industry information associated with the particular type of business 102 in which the digital cockpit 104 is deployed, and window 304 presents information regarding economic indicators pertinent to the business 102. Of course, this small sampling of information is merely illustrative; a great variety of additional information can be presented regarding the business environment in which the business 102 operates.

Window 306 provides information regarding the past course (i.e., history) of the business 102, as well as its present state. Window 308 provides information regarding both the past, current, and projected future condition of the business 102. The cockpit control module 132 can generate the information shown in window 308 using one or more models 136. Although not shown, the cockpit control module 132 can also calculate and present information regarding the level of confidence associated with the business predictions shown in window 308. Additional information regarding the presentation of confidence information is presented in section E of this disclosure. Again, the predictive information shown in windows 306 and 308 is strictly illustrative; a great variety of additional presentation formats can be provided depending on the business environment in which the business 102 operates and the design preferences of the cockpit designer. Additional presentation strategies include displays having confidence bands, n-dimensional graphs, and so on.

The cockpit interface 134 can also present interactive information, as shown in window 310. This window 310 includes an exemplary multi-dimensional response surface 312. Although response surface 312 has three dimensions, response surfaces having more than three dimensions can be presented. The response surface 312 can present information regarding the projected future course of business 102, where the z-axis of the response surface 312 represents different slices of time. The window 310 can further include a display control interface 314, which allows the cockpit user 138 to control the presentation of information presented in the window 310. For instance, in one implementation, the display control interface 314 can include an orientation arrow that allows the cockpit user 138 to select a particular part of the displayed response surface 312, or which allows the cockpit user 138 to select a particular vantage point from which to view the response surface 312.

The cockpit interface 134 further includes another window 316 that provides various control mechanisms. Such control mechanisms can include a collection of graphical input knobs or dials 318, a collection of graphical input slider bars 320, a collection of graphical input toggle switches 322, as well as various other graphical input devices 324 (such as data entry boxes, radio buttons, etc.). These graphical input mechanisms (318, 320, 322, 324) are implemented, for example, as touch sensitive fields in the cockpit interface 134. Alternatively, these input mechanisms (318, 320, 322, 324) can be controlled via other input devices, or can be replaced by other input devices. Exemplary alternative input devices were identified above in the context of the discussion of input device(s) 270 of FIG. 2. The window 316 can also provide an interface to other computing functionality provided by the business; for instance, the digital cockpit 104 can also receive input data from a “meta-model” used to govern a more comprehensive aspect of the business.

Generally speaking, the response surface 312 (or other type of presentation provided by the cockpit interface 134) can provide a dynamically changing presentation in response to various events fed into the digital cockpit 104. For instance, the response surface 312 can be computed using a model 136 that generates output results based, in part, on data collected from the processes (106, 108, . . . 110) and stored in the data warehouses 208. As such, changes in the processes (106, 108, . . . 110) will prompt real time or near real time corresponding changes in the response surface 312. Further, the cockpit user 138 can dynamically make changes to “what-if” assumptions via the input mechanisms (318, 320, 322, 324) of the control panel 316. These changes can induce corresponding lockstep dynamic changes in the response surface 312.

By way of summary, the cockpit interface 134 provides a “window” into the operation of the business 102, and also provides an integrated command and control center for making changes to the business 102. The cockpit interface 134 also allows the cockpit user 138 to conveniently switch between different modes of operation. For instance, the cockpit interface 134 allows the user to conveniently switch between a “what-if” mode of analysis (in which the cockpit user 138 investigates the projected probabilistic outcomes of different case scenarios) and a “do-what” mode of command (in which the cockpit user 138 enters various commands for propagation throughout the business 102). While the cockpit interface 134 shown in FIG. 3 contains all of the above-identified windows (302, 304, 306, 308, 310, 316) on a single display presentation, it is possible to devote separate display presentations for one or more of these windows, etc.

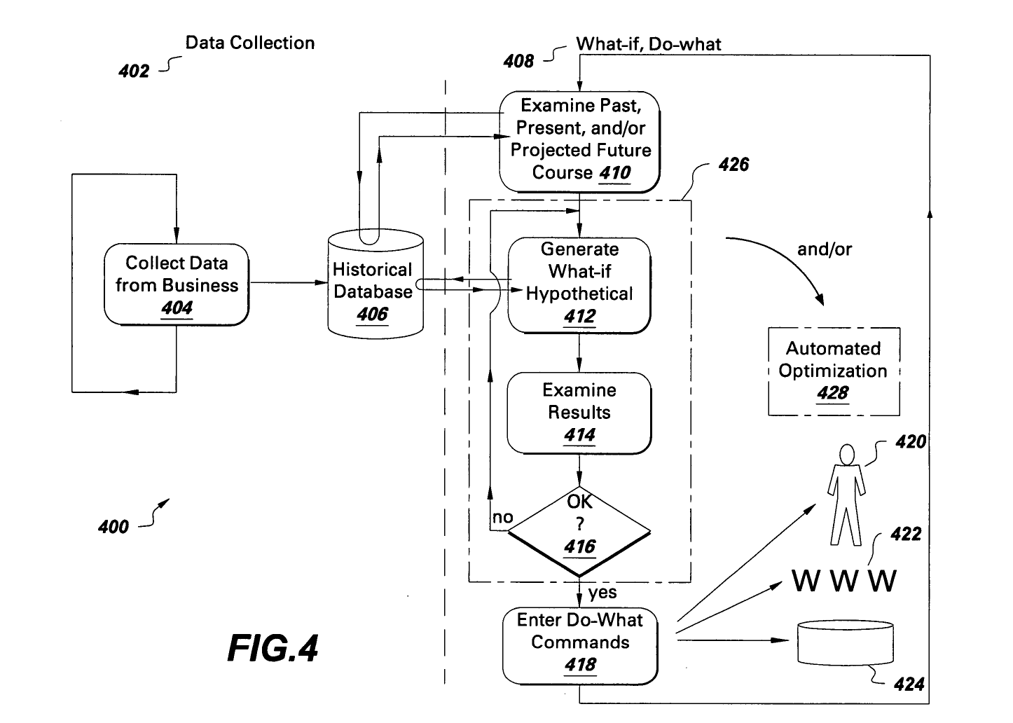

FIG. 4 presents a general exemplary method 400 that describes how the digital cockpit 104 can be used. In a data collection portion 402 of the method 400, step 404 entails collecting data from the processes (106, 108, . . . 110) within the business 102. Step 404 can be performed at prescribed intervals (such as every minute, every hour, every day, every week, etc.), or can be performed in response to the occurrence of predetermined events within the business 102. For instance, step 404 can be performed when it is determined that the amount of information generated by the business processes (106, 108, . . . 110) exceeds a predetermined threshold, and hence needs to be processed. In any event, the business processes (106, 108, . . . 110) forward information collected in step 404 to the historical database 406. The historical database 406 can represent the data warehouse 208 shown in FIG. 2, or some other storage device. The digital cockpit 104 receives such information from the historical database 406 and generates one or more fields of information described in connection with FIG. 1. Such information can include: “what was” information, providing a summary of what has happened in the business 102 in a defined prior time interval; “what-is” information, providing a summary of the current state of the business 102; and “what-may” information, providing forecasts on a projected course that the business 102 may take in the future.

In a what-if/do-what portion 408 of the method 400, in step 410, a cockpit user 138 examines the output fields of information presented on the cockpit interface 134 (which may include the above-described what-has, what-is, and what-may fields of information). The looping path between step 410 and the historical database 406 generally indicates that step 410 utilizes the information stored in the historical database 406.

Presume that, based on the information presented in step 410, the cockpit user 138 decides that the business 102 is currently headed in a direction that is not aligned with a desired goal. For instance, the cockpit user 138 can use the what-may field 144 of cockpit interface 134 to conclude that the forecasted course of the business 102 will not satisfy a stated goal. To remedy this problem, in step 412, the cockpit user 138 can enter various “what-if” hypothetical cases into the digital cockpit 104. These “what-if” cases specify a specific set of conditions that could prevail within the business 102, but do not necessarily match current conditions within the business 102. This prompts the digital cockpit 104 to calculate what may happen if the stated “what-if” hypothetical input case assumptions are realized. Again, the looping path between step 412 and the historical database 406 generally indicates that step 412 utilizes the information stored in the historical database 406. In step 414, the cockpit user 138 examines the results of the “what-if” predictions. In step 416, the cockpit user 138 determines whether the “what-if” predictions properly set the business 102 on a desired path toward a desired target. If not, the cockpit user 138 can repeat steps 412 and 414 for as many times as necessary, successively entering another “what-if” input case assumption, and examining the output result based on this input case assumption.

Assuming that the cockpit user 138 eventually settles on a particular “what-if” case scenario, in step 418, the cockpit user 138 can change the business processes (106, 108, . . . 110) to carry out the simulated “what-if” scenario. The cockpit user 138 can perform this task by entering “do-what” commands into the “do-what” field 148 of the cockpit interface 134. This causes the digital cockpit 104 to propagate appropriate instructions to targeted resources used in the business 102. For instance, command path 420 sends instructions to personnel used in the business 102. These instructions can command the personnel to increase the number of workers assigned to a task, decrease the number of workers assigned to a task, change the nature of the task, change the amount of time spent in performing the task, change the routing that defines the “input” fed to the task, or other specified change. Command path 422 sends instructions to various destinations over a network, such as the Internet (WWW), a LAN network, etc. Such destinations may include a supply chain entity, a financial institution (e.g., a bank), an intra-company subsystem, etc. Command path 424 sends instructions to engines (112, 118, 124) used in the processes (106, 108, . . . 110) of the business 102. These instructions can command the engines (112, 118, 124) to change its operating parameters, change its input data, change its operating strategy, as well as other changes.

In summary, the method shown in FIG. 4 allows a cockpit user 138 to first simulate or “try out” different “what-if” scenarios in the virtual business setting of the cockpit interface 134. The cockpit user 138 can then assess the appropriateness of the “what-if” cases in advance of actually implementing these changes in the business 102. The generation of “what-if” cases helps reduce inefficiencies in the governance of the business 102, as poor solutions can be identified in the virtual realm before they are put into place and affect the business processes (106, 108, . . . 110).

Steps 412, 414 and 416 collectively represent a manual routine 426 used to explore a collection of “what-if” case scenarios. In another implementation, the manual routine 426 can be supplemented or replaced with an automated optimization routine 428. The automated optimization routine 428 can automatically sequence through a number of case assumptions and then select one or more case assumptions that best accomplish a predefined objective (such as maximizing profitability, minimizing risk, etc.). The cockpit user 138 can use the recommendation generated by the automated optimization routine 428 to select an appropriate “do-what” command. Alternatively, the digital cockpit 104 can automatically execute an automatically selected “do-what” command without involvement of the cockpit user 138.

In any event, the output results generated via the process 400 shown in FIG. 4 can be archived, e.g., within the database 234 of FIG. 2. Archiving the generated output results allows these results to be retrieved if these output results are needed again at a later point in time, without incurring the delay that would be required to recalculate the output results.

To summarize the discussion of FIGS. 1-4, three analogies can be made between an airplane cockpit (or other kind of vehicle cockpit) and a business digital cockpit 104 to clarify the functionality of the digital cockpit 104. First, an airplane can be regarded as an overall engineered system including a collection of subsystems. This engineered system enables the flight of the airplane in a desired manner under the control of a pilot or autopilot. In a similar fashion, a business 102 can also be viewed as an engineered system comprising multiple processes and associated systems (e.g., 106, 108, 110). Like an airplane, the business digital cockpit 104 also includes a steering control module 152 that allows the cockpit user 138 or “auto-pilot” (representative of the automated optimization routine 428 and “do what” functionality) to make various changes to the processes (106, 108, . . . 110) to allow the business 102 to carry out a mission in the face of various circumstances (with the benefit of information in past, present, and future time domains).

Second, an airplane cockpit has various gauges and displays for providing substantial quantities of past and current information pertaining to the airplane's flight, as well as to the status of subsystems used by the airplane. The effective navigation of the airplane demands that the airplane cockpit presents this information in a timely, intuitive, and accessible form, such that it can be acted upon by the pilot or autopilot in the operation of the airplane. In a similar fashion, the digital cockpit 104 of a business 102 also can present summary information to assist the user in assessing the past and present state of the business 102, including its various “engineering” processes (106, 108, . . . 110).

Third, an airplane cockpit also has various forward-looking mechanisms for determining the likely future course of the airplane, and for detecting potential hazards in the path of the airplane. For instance, the engineering constraints of an actual airplane prevent it from reacting to a hazard if given insufficient time. As such, the airplane may include forward-looking radar to look over the horizon to see what lies ahead so as to provide sufficient time to react. In the same way, a business 102 may also have natural constraints that limit its ability to react instantly to assessed hazards or changing market conditions. Accordingly, the digital cockpit 104 of a business 102 also can present various business predictions to assist the user in assessing the probable future course of the business 102. This look-ahead capability can constitute various forecasts and “what-if” analyses.

In the overview of the business systems as described in relation to FIG. 1 to FIG. 4 above, a high-level business system view is presented wherein a number of transfer functions are designed and deployed to quantitatively express the functioning of the business system and its various sub-systems and components. As is evident, in the business system as represented by the digital cockpit 104, there are many subsystems and components that convert one or more inputs into outputs. It is of primary interest to know and formulate the relationship between such output and the respective input parameters for proper control and monitoring of the business system using the digital cockpit 104 outlined above. As noted above, a relationship between an output and a set of input parameters is known as a transfer function. Like the system, the subsystems and components may have known transfer functions and control couplings that determine their respective behavior.

An exemplary transfer function used in the digital cockpit 104 can represent a mathematical equation or algorithmic relationship or any other function fitted to empirical data collected over a span of time. Alternatively, an exemplary transfer function can represent a mathematical equation or algorithmic relationship or any other function derived from “first principles” (e.g., based on a consideration of economic principles). Other exemplary transfer functions can be formed based on other considerations. In operation, a transfer function translates one or more input(s) into one or more output(s) using a translation function. The translation function can also be implemented using a mathematical or algorithmic model or other form of mapping strategy. For instance, a transfer function of the engine 112 of FIG. 1 simulates the behavior of an engine 112 by mapping a set of process inputs to projected process outputs. The behavior of these engines 112 therefore can be described, controlled and monitored using these transfer functions.

In another implementation, a transfer function of the digital cockpit 104 maps one or more independent variables (e.g., one or more X variables) to one or more dependent variables (e.g., one or more Y variables). For example, referring to FIG. 1, a model 136 of FIG. 1 that employs a transfer function can map one or more X variables that pertain to historical information collected from the processes (106, 108, . . . 110) into one or more Y variables that deterministically and/or probabilistically forecast what is likely to happen in the future. Such models 136 may use, for example, discrete event simulations, continuous simulations, Monte Carlo simulations, regressive analysis techniques, time series analyses, artificial intelligence analyses, extrapolation and logic analyses, etc. Such X variables can represent different kinds of information depending on the configuration and intended use of the model 136. Generally, input data may represent data collected from the business 102 and stored in the database warehouses 208 mentioned in relation to FIG. 2. Input data can also reflect input assumptions specified by the cockpit user 138, or automatically selected by the digital cockpit 104.

In yet another implementation, there are scenario building applications where transfer functions are at the heart of conversion of different inputs into outputs. Such scenario building cases may typically include “what-if” and “do-what” situations. The term “what-if” encompasses any kind of projection of “what may happen” given any kind of input assumptions. In one such case, a user may generate a prediction by formulating a forecast based on the past course of the business. The prediction can be generated using the transfer functions to predict a particular value of the output parameter based on a number of particular values of the input parameters. Here, the input assumption is defined by the actual course of the business. In another case, a user may generate a prediction by inputting a set of assumptions that could be present in the business (but which do not necessarily reflect the current state of the business), which prompts the system to generate a forecast of what may happen if these assumptions are realized. Here, the forecast assumes more of a hypothetical “what if” character (e.g., “If X is put into place, then Y is likely to happen”) or “do-what” character (e.g., “What values of X are required when a particular value of Y is desired?”).

In still another case, the cockpit control module 132 can include functionality for automatically analyzing information received from the processes (106, 108, . . . 110), and then automatically generating “what-if” or “do-what” commands for dissemination to appropriate target resources within the processes (106, 108, . . . 110) based on automatic transfer function building functionalities. As will be described in greater detail below, such automatic control can include mapping various input conditions to various instructions to be propagated into the processes (106, 108, 110). Such automatic control of the business 102 can therefore be likened to an automatic pilot provided by a vehicle. In yet another implementation, the cockpit control module 132 generates a series of recommendations regarding different courses of actions that the cockpit user 138 might take, and the cockpit user 138 exercises human judgment in selecting a transfer function from among the recommendations (or in selecting a transfer function that is not included in the recommendations).

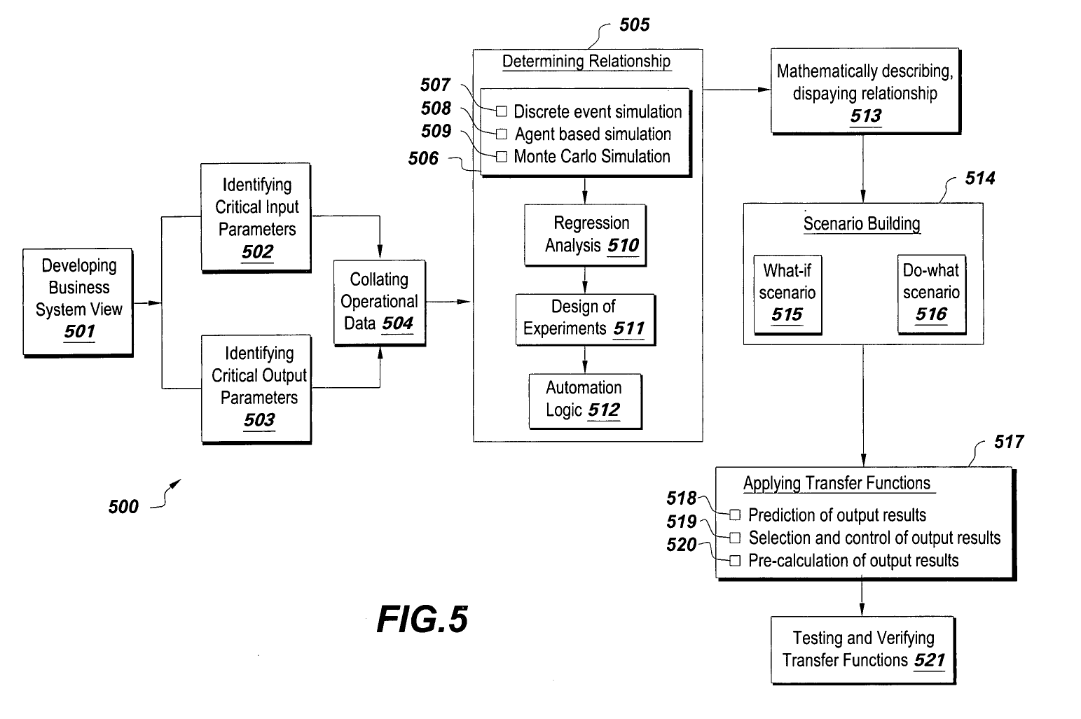

FIG. 5 illustrates a method 500 of building a transfer function according to one embodiment. The method 500 begins with developing at least one high-level business system view as in functional block 501 such that the relevant transfer functions are configured to quantitatively express the functioning of the business system and its different sub-systems and components. In step 502, a number of input parameters associated with one or more of the resources used in the business processes are identified. In step 503 one or more output parameter (503) associated with the operation of the business processes are identified. Continuing, operational data are collected that associate the input parameters with the output parameter based on an actual operation of the process as in the functional block 504. Next, a relationship between the output parameter and the input parameters is determined based on the operational data as in the functional block 505. There are various simulations techniques for determining the relationship as indicated in functional block 506. Such simulation techniques may include discrete event simulations (507), Agent based simulations (508), Monte Carlo simulations (509) etc. In other embodiments, non-simulation based techniques are used. For instance, regression analysis techniques (510), and design of experiments (511) can be used. In yet another embodiments, a relationship between the output parameters and the input parameters may be determined automatically using typical automations logics as outlined in step 512.

In functional block 513, the relationship between the output parameter and the input parameters is mathematically or algorithmically described and displayed using the transfer function. Continuing further, in functional block 514, multiple business scenarios are built up using the transfer functions developed in step 505. Two exemplary scenarios are “what-if” and “do-what” as illustrated in step 515 and step 516 respectively. In the next step 517, the transfer functions are applied to accomplish other functionalities of the digital cockpit 104 such as prediction of output results as in functional block 518, selection and control of output results as in functional block 519 and pre-calculation of output results as in functional block 520. At the end, the method 500 is complete only when the transfer functions are tested and verified as in functional block 521. Each of these steps will be explained in more details below.

As mentioned above, the method 500 starts with the identification of a business system view (step 501) having a number of processes wherein each of the processes (106, 108, . . . 110) as in FIG. 1 have a collection of resources. The term “resources” as used herein has broad connotation and can include any aspect of the process that allows it to transform input items into output items. Of all the resources as mentioned above, only some are identified as the critical inputs (step 502) for monitoring by the digital cockpit. The system takes these inputs and processes them and converts them into outputs that are meaningful for the business for its operation and existence. The digital cockpit 104 is used at the same time to monitor the output variables (step 503). The objective of the transfer function building method is to typically provide output results (e.g., one or more Y variables) based on input data (e.g., one or more X variables). Such X variables can represent different kinds of information depending on the configuration and intended use of the system and its different components and subcomponents. Typically, input data may represent data collected from the business 102 and stored in the database warehouses 208 shown in FIG. 2. Input data can also reflect input assumptions specified by the cockpit user 138, or automatically selected by the digital cockpit 104.

The Y variable mentioned above can be a function of multiple X variables and a subset of these multiple X variables may be “actionable”. An X variable is said to be “actionable” when it corresponds to an aspect of the business 102 that the business 102 can deliberately manipulate. For instance, presume that the output Y variable is a function, in part, of the size of the business's 102 sales force. A business 102 can control the size of the workforce by hiring additional staff, transferring existing staff to other divisions, laying off staff, etc. Hence, the size of the workforce represents an actionable X variable.

In operation, one or more of the X variables can be varied through the use of any control mechanism of the digital cockpit 104 such as the control window 316 shown in FIG. 3. Returning briefly to FIG. 3, as explained, the digital cockpit interface 134 includes a window 316 that provides a collection of graphical input devices (318, 320, 322, 324). In the context of FIG. 3, the graphical input devices (318, 320, 322, 324) can be associated with such actionable X variables. In another embodiment, the graphical input devices (318, 320, 322, 324) can be associated with an X variable that is not actionable. A user may not be able to take action to change a non-actionable input, yet the non-actionable inputs are important because without these, various business scenarios cannot be constructed. Typical examples of such non-actionable inputs include “interest rate” or “cost of raw materials”.

Moreover, the digital cockpit 104 can also be configured in such a manner that a cockpit user's 138 variation of one or more of these inputs will cause the outputs to change perceptively and meaningfully. Hence, through an appropriate display visualization technique as will be explained later, the user 138 can gain added insight into the behavior of the system's transfer functions. In one implementation, the digital cockpit 104 is configured to allow the cockpit user 138 to select the variables that are to be assigned to the axes of the response surface 312 of FIG. 3. For instance, the cockpit user 138 can initially assign a first X variable to one of the axes in response surface 312, and then later reassign that axis to another of the X variables. In addition, the digital cockpit 104 can be configured to dynamically display changes to the response surface 312 while the cockpit user 138 varies one or more input mechanisms (318, 320, 322, 324). The real-time coupling between actuations made in the control window 316 and changes presented to the response surface 312 allows the cockpit user 138 to gain a better understanding of the characteristics of the response surface 312.

Referring back to FIG. 5, method 500 for building a transfer function may next include the time-intensive tasks of collating and collecting operational data (504) that associate the input parameters with the output parameters based on an actual operation of the business process from historical databases and other sources. As to the data collection involves collecting information from processes within a business, and then storing this information in a historical database such as the data warehouse 208 described in the context of FIG. 2. In the next stage, the data is transformed into a desired form, performing various calculations, etc. The processing is further refined for those applications that involve performing several iterations of calculations. For instance, for those applications that seek to construct a probability distribution of the input and the output parameters, the analyses are repeated multiple times to build probability distributions and confidence intervals using well established analytical techniques.

Referring to FIG. 5 again, in the next step (505) after collecting all operational data, a relationship between the output parameter and the input parameters is determined based on the operational data as in step 504. The digital cockpit 104 (see FIG. 1) includes a cockpit control module 132 coupled to a cockpit interface 134. The cockpit control module 132 includes one or more models 136. A model 136 transforms information collected by the processes (106, 108, . . . 110) into an output using one or more transfer function(s). As explained above, one such transfer function maps one or more independent variables (e.g., one or more X variables) into one or more dependent variables (e.g., one or more Y variables). In a specific example, the digital cockpit model 104 can employ a transfer function that can map one or more X variables pertaining to historical information collected from various processes of the system as in the previous step (504) into one or more Y variables that deterministically and/or probabilistically forecast what is likely to happen in the future.

In one embodiment, methods based on simulating (step 506) the business process based on the usage of the resources in the business process are used to select the input parameters that are critical to the output parameters and to conjoin the value gained with each of the selected input parameters and finally to determining the elasticity of the output parameter with regard to the selected input parameters. More specifically, such simulation techniques include discrete event simulations (step 507), agent based simulation (step 508), continuous simulations, Monte Carlo simulations (step 509), etc. In other embodiments, non-simulation based techniques are used. For instance, regression analysis techniques (step 510), design of experiments (step 511), time series analyses (step 522), artificial intelligence analyses (step 523), extrapolation and logic analyses, etc yield transfer functions that mathematically or algorithmically describe a relationship between an output parameter and a number of input parameters using the transfer function. In another embodiment, an automation logic as part of step 512 calculates a transfer function from input and output data without human participation. This functionality will be explained in more details below.

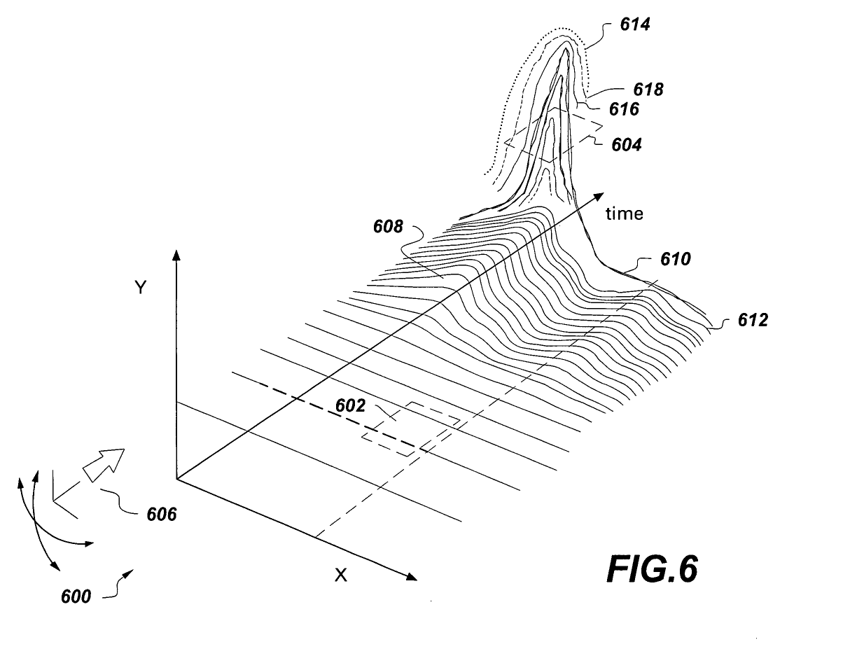

Once a relationship between the output parameters and the input parameters may be determined, the next significant step is to display the input parameters, the output parameters and the transfer functions as in step 513 of FIG. 5. Now, referring back to the method 500 of FIG. 5, the step of displaying the transfer function (513) includes mapping a response surface based on the values of the input parameters, the output parameters and their transfer functions. The response surface graphically shows the relationship between the output variable and the input variables as expressed in a transfer function. This is illustrated in more detail in FIG. 6. This figure shows a response surface 600 that is the result of a collection of transfer functions that map X variables into corresponding output dependent Y variables. The transfer function output is further computed for different slices of time, and, as such, time forms another variable in the transfer function. Of course, the shape of the response surface 600 shown in FIG. 6, and the collection of input assumptions, is merely illustrative. In cases where the transfer function involves more than three dimensions, the digital cockpit 104 can illustrate such additional dimensions by allowing the cockpit user to toggle between different graphical presentations that include different respective selections of variables assigned to axes, or by using some other graphical technique.

Probability distribution curves as illustrated in FIG. 6 typically assume the shape of a symmetrical peak, such as a normal distribution, triangular distribution, or other kind of distribution. The peak identifies the calculated result having the highest probability of being realized. The total area under the probability distribution curve is 1, meaning that that there is a 100% probability that the calculated result will fall somewhere in the range of calculated values spanned by the probability distribution. In another implementation, the digital cockpit 104 can represent the information presented in the probability distribution curve using other display formats. By way of clarification, the term “probability distribution” is used broadly in this description. This term describes curves that present mathematically calculated probability distributions, as well as curves that present frequency count information associated with actual sampled data (where the frequency count information can often approximate a mathematically calculated probability distribution).

To elaborate further, the response surface 600 of FIG. 6 illustrates an exemplary representation of the transfer functions and it is formed by a number of probability distribution curves such as 610, 612. The exemplary representation relates to an input having a portion 602 that are relatively flat and a portion 604 that changes drastically. FIG. 6 at the same time represents the confidence associated with any predicted output by a series of probability distribution curves such as 610, 612. For instance, in the response surface 600 the probability distributions curve 610 is sharper and the probability distribution curve 612 is relatively much flatter. However, both 610 and 612 can convey the confidence associated with a particular predicted output. More specifically, a typical probability distribution curve represents a calculated output variable on the horizontal axis, and probability level on the vertical axis. For instance, if several iterations of a calculation are run, the vertical axis can represent the prevalence at which different predicted output values are encountered (such as by providing count or frequency information that identifies the prevalence at which different predicted output values are encountered). A point along the probability distribution curve thus represents the probability that a value along the horizontal axis will be realized if the case assumption is implemented in the business.

Generally, different factors can contribute to uncertainty in the predicted output result. For instance, the input information and assumptions fed to the digital cockpit 104 may have uncertainty associated therewith. Such uncertainty may reflect variations in various input parameters associated with different tasks within the method 500, variations in different constraints that affect the method 500, as well as variations associated with other aspects of the method 500. This uncertainty propagates through the digital cockpit 104, and results in uncertainty in the predicted output result. The probabilistic distribution in the output of the method 500 can represent the actual variance in the collection of information fed into the method 500. In another implementation, uncertainty in the inputs fed to the digital cockpit 104 can be simulated (rather than reflecting variance in actual sampled business data). In addition to the above-noted sources of uncertainty, the prediction strategy used by the digital cockpit 104 may also have inherent uncertainty associated therewith. Known modeling techniques can be used to assess the uncertainty in an output result based on the above-identified factors and appropriate action can be taken.

In the specific context of transfer function building, the digital cockpit 104 provides a prediction of an output parameter value in response to the input parameters, as well as a level of confidence associated with this prediction. For instance, the digital cockpit 104 can generate a forecast that a particular combination of input parameters, output parameters and transfer function, in other words, ‘an input case assumption’ will result in a cycle time that consists of a certain amount of hours coupled with an indication of the statistical confidence associated with this prediction. That is, for example, the digital cockpit 104 can generate an output that informs the cockpit user 138 that a particular parameter setting will result in its output such as a cycle time of 40 hours, and that there is a 70% confidence level associated with this prediction (that is, there is a 70% probability that the actual measured cycle time will be 40 hours).

In an exemplary situation, a cockpit user 138 may be dissatisfied with this predicted result for one of two reasons (or both reasons). First, the cockpit user 138 may find that the predicted cycle time is too long. For instance, the cockpit user 138 may determine that a cycle time of 30 hours or less is required to maintain competitiveness in a particular business environment. Second, the cockpit user 138 may feel that the level of confidence associated with the predicted result is too low. For a particular business environment, the cockpit user 138 may want to be assured that a final product can be delivered with a greater degree of confidence. This can vary from business application to business application. For instance, the customers in one financial business environment might be highly intolerant to fluctuations in cycle time, e.g., because the competition is heavy, and thus a business with unsteady workflow habits will soon be replaced by more stable competitors. In other business environments, an untimely output product may subject the customer to significant negative consequences (such as by holding up interrelated business operations), and thus it is desirable to predict the cycle time with a relatively high degree of confidence. Displaying the transfer functions help a user 138 in speculating different scenarios and take preparatory or corrective actions in anticipation.

A comparison of probability distribution curve 612 and probability distribution curve 610 allows a cockpit user 138 to assess the accuracy of the digital cockpit's 104 predictions and take appropriate corrective measures in response thereto. In one case, the cockpit user 138 can rely on his or her business judgment in comparing distribution curves 610 and 612. In another case, the digital cockpit 104 can provide an automated mechanism for comparing salient features of distribution curves 610 and 612. For instance, this automated mechanism can determine the variation between the mean values of distributions curves 610 and 612, the variation between the shapes of distributions 610 and 612, and so on.

In accordance with one embodiment, business 102 and the markets within which it operates are examples of typical business systems. The input and the output parameters of these systems can be linear in nature at times and non-linear at other times. In another implementation, the input and the output parameters may be stochastic in nature or may be dynamic. Moreover, not all observations in these systems are mathematically describable. When they are mathematically describable, open and closed form transfer functions may be derived. An open form transfer function describes the relationship between a set of input and output parameters such that only the output parameters are influenced by the input parameters and not vice versa. On the other hand, a closed form transfer function describes the relationship between a set of input and output parameters such that a part or whole of the output parameters are fed back into the system to influence the input parameters during successive operations of the system. For example, an open form transfer function may describe the conversion relationship between a particular raw material inputs of a factory into the final goods produced. On the other hand, a closed form transfer function may describe the conversion relationship between the gas burning rate and the heat output of a thermostat-controlled heater. In this instance, the heat output at any point of time influences the gas-burning rate partly or wholly. In essence, the present embodiment is a framework applicable to the functional areas of a business where augmentation of business judgment with quantitative methods and systems is beneficial.

Referring back to the visual representation of these transfer functions in FIG. 6 and continuing further on interactive display of a response surface, arrow 606 in FIG. 6 represents a mechanism for allowing a cockpit user to rotate the response surface 600 in any direction to view the response surface 600 from different vantage points. Momentarily referring back to FIG. 3, the cockpit interface 134 can in a similar fashion, present interactive information, as shown in window 310. This window 310 includes an exemplary multi-dimensional response surface 312. Although response surface 312 has three dimensions, response surfaces having more than three dimensions can be presented. The response surface 312 can present information regarding the projected future course of business 102, where the z-axis of the response surface 312 represents different slices of time. The window 310 can further include a display control interface 314, which allows the cockpit user 138 to control the presentation of information presented in the window 310. For instance, in one embodiment, the display control interface 314 can include an orientation arrow that allows the cockpit user 138 to select a particular part of the displayed response surface 312, or which allows the cockpit user 138 to select a particular vantage point from which to view the response surface 312. Moreover the display further includes display of all detailed calculations involved in determining the relationship between the output parameter and the input parameters.

As mentioned earlier, business system 100 may typically include a collection of subsystems and components and these subsystems and components of the may have their known transfer functions and control couplings that determine their respective behavior. In keeping with this system-subsystem viewpoint, the digital cockpit 104 can determine whether a response surface can be simplified by breaking it into multiple transfer functions that can be used to describe the component parts of the response surface. For example, consider FIG. 6 once again. As described above, the response surface 600 shown there includes a relatively flat portion 602 and a rapidly changing portion 604. The term “flat”, as used here, refers to a part of the surface that can be described by a simple mathematical expression. Although an overall mathematical model may (or may not) describe the entire response surface 600, it may be the case that different transfer functions can also be derived to describe its flat portion 602 and rapidly changing portion 604. Thus, instead of, or in addition to, calculating final output results at the system level, the digital cockpit 104 can also store sub-system or component transfer functions that can be used to describe the response surface's 600 distinct portions. During later use, a cockpit user may request an output result that corresponds to a part or region of interest in the response surface 600 in terms of range and scale of operation as associated with one of component transfer functions. In that case, the digital cockpit 104 can be configured to use this component transfer function to calculate the output results.

The system and sub-system analysis feature described above has the capacity to improve the overall response time of the digital cockpit 104. For instance, an output result corresponding to the flat portion 602 can be calculated relatively quickly, as the transfer function associated with this region would be relatively straightforward, while an output result corresponding to the rapidly changing portion 604 can be expected to require more time to calculate. By expediting the computations associated with at least part of the response surface 600, the overall or average response time associated with providing results from the response surface 600 can be improved (compared to the case of using a single complex model to describe all portions of the response surface 600). The use of a separate transfer function to describe the flat portion 602 can be viewed as a “shortcut” to providing output results corresponding to this part of the response surface 600. In addition, providing separate transfer functions to describe the separate portions of the response surface 600 may provide a more accurate modeling of the response surface (compared to the case of using a single complex model to describe all portions of the response surface 600).

In operation, the subsystems and the component systems also iteratively follow the same steps of building a transfer function as is done at the system level. To recount, the steps are—developing a number of sub-processes and component processes that are part of the business process; identifying a number of input parameters associated with one or more of the resources used in the identified sub-processes and component processes; identifying one or more output parameter associated with the operation of the of sub-processes and the component processes; collecting operational data that associate the input parameters with the output parameter based on an actual operation of the sub-processes and the component processes; determining at least one relationship between the output parameter and the input parameters based on the operational data; and mathematically or algorithmically describing the relationship between the at least one output parameter and the input parameters using sub-process transfer function.

Whatever be the level of abstraction such as system or subsystem, there are different techniques for representing the granularity of analysis, uncertainty, changeability and desirability associated with the transfer functions derived by the method 500 of FIG. 5 in accordance with one embodiment. Appreciation of these probabilistic parameters help getting a better control over the overall operational, tactical and strategic management of the business system

The digital cockpit 104 takes the nature of the response surface 600 and thereby the underlying transfer function into account when deciding what calculations to perform. For instance, the digital cockpit 104 need not perform fine-grained analysis for the flat portion 602 of FIG. 6, since results do not change significantly as a function of the input variables for this portion 602. It is sufficient to perform a few calculations in this flat portion 602, that is, for instance, to determine the output Y variables representative of the flat surface in this portion 602.

In another embodiment, the digital cockpit 104 will make relatively fine-grained calculation for the portion 604 that rapidly changes, because a single value in this region is in no way representative of the response surface 600 in general. Other regions in FIG. 6 have a response surface that is characterized by some intermediary between flat portion 602 and rapidly changing portion 604. Accordingly, the digital cockpit 104 will provide some intermediary level of calculation in these areas, the level of calculation being a function of the changeability of the response surface 600 in these areas. More specifically, in one case, the digital cockpit 104 can allocate discrete levels of analysis to be performed for different portions of the response surface 600 depending on whether the rate of change in these portions falls into predefined ranges of variability. In another case, the digital cockpit 104 can smoothly taper the level of analysis to be performed for the response surface 600 based on a continuous function that maps surface variability to levels that define the graininess of computation to be performed. Graininess being defined as the density of observed data from either modeling scenarios or actual process observations. In areas where there are non-linearities more observations (granularity) are desired.

One way to assess the changeability of the response surface 600 is to compute a partial derivative of the response surface 600 (or a second derivative, third derivative, etc.). A derivative of the response surface 600 will provide an indication of the extent to which the response surface changes. In yet another embodiment, the mapping includes mapping over a region of interest constructed based on a predetermined range or a predetermined scale of values of the input parameters or the output parameter. As it is determined that there is a non linear “Y” response for a given “x” or “xs”, more analytical scenarios are made with finer changes in the xs.

Like changeability, the display mechanism of the transfer function includes ways to illustrate the feature of uncertainty. Referring to FIG. 6, the output generated by a forward-looking method of the digital cockpit 104 will typically include some uncertainty associated therewith. This uncertainty may stem, in part, from the uncertainty in the input values that are fed to the digital cockpit 104 (due to natural uncertainties regarding what may occur in the future). In addition to the above-noted sources of uncertainty, the prediction strategy used by the digital cockpit 104 may also have inherent uncertainty associated therewith. Known modeling techniques can be used to assess the uncertainty in an output result based on the factors mentioned above.

Any two-dimensional curve in FIG. 6 illustrates the uncertainties associated with the transfer function of the forward-looking method of the digital cockpit 104. The vertical axis of the curve represents the transfer function of an exemplary forward-looking method of the digital cockpit 104, while the horizontal axis represents time. Curve 612 represents a point estimate response transfer function of the method (e.g., the “calculated value”) as a function of time. Confidence bands 614, 616, and 618 reflect the level of certainty associated with the response transfer function 602 of the digital cockpit 104 at different respective confidence levels. For instance, it is indicated that there is a 10% confidence level that future events will correspond to a value that falls within band 614 (demarcated by two solid lines that straddled the curve 612). There is a 50% confidence level that future events will correspond to a value that falls within band 616 (demarcated by two dashed lines that straddled the curve 612). There is a 90% confidence level that future events will correspond to a value that falls within band 618 (demarcated by two outermost dotted lines that straddled the curve 612). All of the bands (614, 616, 618) widen as future time increases. Accordingly, it can be seen that the confidence associated with the digital cockpit's 104 transfer function decreases as the predictions become progressively more remote in the future. Stated another way, the confidence associated with a specific future time period will typically increase as the business moves closer to that time period.

It should be noted that objects 608, 610, and 612 in FIG. 6 are denoted as relatively “sharp” response curves. In actuality, however, the objects may reflect a probabilistic output distribution. The sharp curves can represent an approximation of the probabilistic output distribution, such as the mean of this distribution. Arrow 606 again indicates that the cockpit user is permitted to change the orientation of the response surface shown in FIG. 6. Further, the control window 316 of FIG. 3 gives the cockpit user flexibility in assigning variables to different axes shown in FIG. 6.

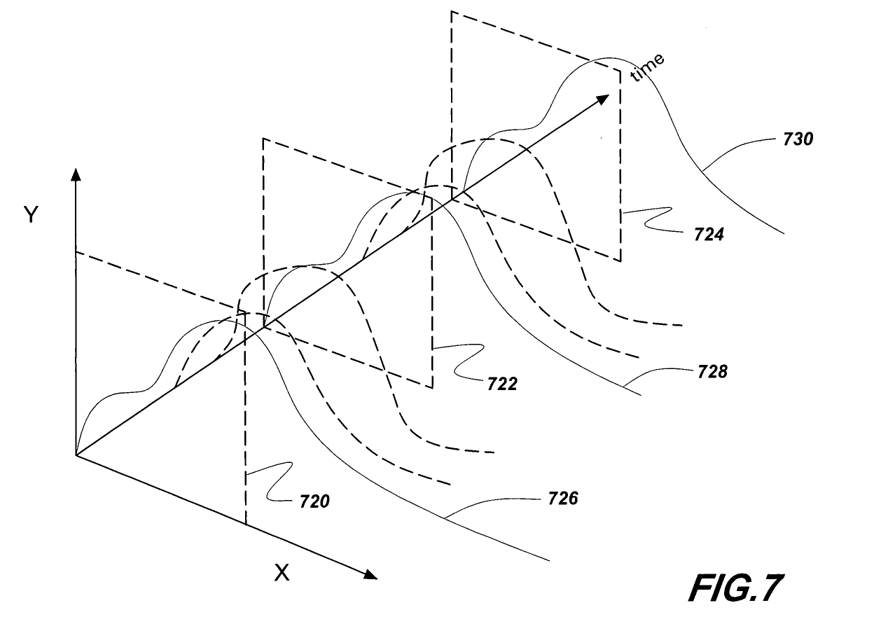

In yet another embodiment, instead of confidence bands, different levels of uncertainty may be visually represented by changing the size of the displayed object (where an object represents an output response curve). In this instance, the probability associated with the output results is conveyed by the size of the objects rather than a spatial distribution of points. This technique simulates the visual uncertainty associated with an operator's field of view while operating a vehicle. More specifically, FIG. 7 simplifies the discussion of a response surface by representing only three slices of time (720, 722 and 724). Object 726 is displayed on time slice 720, object 728 is displayed on time slice 722, and object 730 is displayed on time slice 724. As time progresses further into the future, the uncertainty associated with digital cockpit 104 increases. Accordingly, object 726 is larger than object 728, and object 728 is larger than object 730. Although only three objects (726, 728, 730) are shown, many more can be provided, thus giving an aggregate visual appearance of a solid object (e.g., a solid response surface). Viewed as a whole, this curve thus simulates perspective effect in the physical realm, where an object at a distance is perceived as “small,” and hence it can be difficult to discern. A cockpit user can interpret the presentation shown in FIG. 7 in a manner analogous to assessments made by an operator while operating a vehicle. For example, the cockpit user may note that there is a lack of complete information regarding objects located at a distance because of the small optically perceived “size” of these objects. However, the cockpit user may not regard this shortcoming as posing an immediate concern, as the business has sufficient time to gain additional information regarding the object as the object draws closer and to subsequently take appropriate corrective action as needed.

In another embodiment, an alternative technique may be used for representing uncertainty in a response surface, such as, by using display density (not shown) associated with the display surface to represent uncertainty. Again, on different slices of time, different response curves representing different transfer functions may be represented. As time progresses further into the future, the uncertainty associated with the output of the digital cockpit 104 increases, and the density of the response curves decreases in proportion. That is, the foremost response curve will have maximum density and the further one moves less dense is that object. This has the effect of fading out of objects that have a relatively high degree of uncertainty associated therewith. This concept of using density of a response curve as a visual aid to illustrate uncertainty associated with a business situation has been elaborated in greater details in the discussion relating to FIG. 15 of U.S. patent application Ser. No. 10/339,166, filed on Jan. 9, 2003, entitled “Digital Cockpit”. Present application is a continuation-in-part (CIP) of the same application.

Referring back to control window 316 of FIG. 3 can allow the user to vary the density associated with the output results, such as by turning a knob (or other input mechanism) that changes density level. This can have the effect of adjusting the contrast of the displayed object with respect to the background of the display presentation. For instance, assume that the digital cockpit 104 is configured to display only output results that exceed a prescribed density level. Increasing the density level offsets all of the density levels by a fixed amount, which results in the presentation of a greater range of density values. Decreasing the density levels offsets all of the density levels by a fixed amount, which results in the presentation of a reduced range of density values. This has the effect of making the aggregate response surface shown in FIG. 6 grow “fatter” and “thinner” as the density input mechanism is increased and decreased, respectively. In one embodiment, each dot that makes up a density rendering can represent a separate case scenario that is run using the digital cockpit 104. In another embodiment, the displayed density is merely representative of the probabilistic distribution of the output results (that is, in this case, the dots in the displayed density do not directly correspond to discrete output results).

Like changeability and uncertainty, another feature of the transfer function building and displaying method that can be monitored and manipulated is desirability. By successively varying the collection of input parameters in the cockpit interface 134, the cockpit user 138 can identify particularly desirable portions of the response surface in which to operate the business method 500. One aspect of “desirability” pertains to the generation of desired target results. For instance, as discussed above, the cockpit user 138 may want to find that portion of the response surface that provides a desired value of the output parameter such as cycle time (e.g., 40 hours, 30 hours, etc.). Another aspect of desirability pertains to the probability associated with the output results. The cockpit user 138 may want to find that portion of the response surface that provides adequate assurance that the method 500 can realize the desired target results (e.g., 70% confidence 80% confidence, etc.).

In another implementation, another aspect of desirability pertains to the generation of output results that are sufficiently robust to variation. This will assure the cockpit user 138 that the output results will not dramatically change when only a small change in the case assumptions and/or “real world” conditions occurs. Taken all together, it is desirable to find the parts of the response surface that provide an output result that is on-target as well as robust (e.g., having suitable confidence and stability levels associated therewith). The cockpit user 138 can use “what-if” analysis to identify those parts of the response surface that the business distinctly does not want to operate within. The knowledge gleaned through this kind of use of the digital cockpit 104 serves a proactive role in steering the business away from a an undesired direction, such as for example, accepting an order it can not fulfill, stocking out, exhausting capital and etc. business environment that it has ventured into due to unforeseen circumstances or towards a predetermined business goal when the environment is conducive.

According to one embodiment, a transfer function that quantifies a relationship between input and output parameters of a business system and is integrated into a business intelligence system lends itself to business analysis within a business (step 514). The business analysis that is featured according to this embodiment pertains to business prediction. Generally, the term “prediction” is used broadly in this application and the forecast assumes more of a hypothetical “what if” character (e.g., “If X is put into place, then Y is likely to happen”) or “do-what” character (e.g., “What values of X are required when a particular value of Y is desired?”).

Drawing a parallel with a physical cockpit of an airplane once more, an airplane cockpit has various forward-looking mechanisms for determining the likely future course of the airplane, and for detecting potential hazards in the path of the airplane. For instance, the engineering constraints of an actual airplane prevent it from reacting to a hazard if given insufficient time. As such, the airplane may include forward-looking radar to look over the horizon to see what lies ahead so as to provide sufficient time to react. In the same way, a business 102 may also have natural constraints that limit its ability to react instantly to assessed hazards or changing market conditions. Accordingly, the digital cockpit 104 of a business 102 also can use the transfer function to present various business predictions to assist the user in assessing the probable future course of the business 102. Referring to FIG. 5, this look-ahead capability can be augmented by getting an insight into the transfer functions that constitute various forecasts and “what-if” and “do-what” analyses as indicated in blocks 515 and 516 respectively.

In one embodiment, the predictive or forward looking capability of transfer functions can be used to perform “what-if” analysis (step 515). Referring to FIG. 1, the cockpit interface 134 presents another field 146 for receiving hypothetical case assumptions from the cockpit user 138 (referred to as a “what-if” field). More specifically, the “what-if” field 146 allows the cockpit user 138 to enter information into the cockpit interface 134 regarding hypothetical or actual conditions within the business 102. The digital cockpit 104 will then compute various consequences of the identified conditions within the business 102 and present the results to the cockpit user 138 for viewing in the “what-if” display field 146.

Now referring to FIG. 3, in this embodiment, the input mechanisms (318, 320, 322, 324) provided in the window 320 can be used to input various “what-if” assumptions. The entry of this information prompts the digital cockpit 104 to generate scenario forecasts based on the input “what-if” assumptions. More specifically, the cockpit interface 134 can present output results using the two-dimensional presentation shown in window 308, the three-dimensional presentation shown in window 310, an n-dimensional presentation (not shown), or some other format (such as bar chart format, spread sheet format, etc.).

For instance, to simulate a “what-if” scenario, the cockpit user 138 adjusts the input devices (318, 320, 322, 324) to select a particular permutation of X variables. X variables may be actionable or non-actionable. The digital cockpit 104 responds by simulating how the business 102 would react to this combination of input X variables as if these X variables were actually implemented within the business 102. The digital cockpit's 104 predictions can be presented in the window 310, which displays an n-dimensional response surface 312 that maps the output result Y variable as a function of other variables, such as time, and/or possibly one of the X variables. Thus, in a “what-if” simulation mode, the cockpit user 138 can experiment with different permutations of these X variables.

In another implementation, an input case assumption can also include one or more assumptions that are derived from selections made. In response, the digital cockpit 104 simulates the effect that this input case assumption will have on the business method 500 by generating a “what-if” output result using one or more transfer function(s). The output result can be presented as a graphical display that shows a predicted response surface, e.g., as in the case of response surface 312 of window 310 (in FIG. 3). The cockpit user 114 can examine the predicted output result and decide whether the results are satisfactory. That is, the output results simulate how the business will perform if the “what-if” case assumptions were actually implemented in the business. If the results are not satisfactory (e.g., because the results do not achieve a desired objective of the business), the user can adjust the input parameters again to provide a different case assumption, and then again examine the “what-if” output results generated by this new input case assumption. As discussed, this process can be repeated until the cockpit user 138 is satisfied with the output results. At this juncture, the cockpit user 138 then uses the “do-what” functionality (step 516) to actually implement the desired input case assumption represented by the final setting of “what-if” assumption knobs.

More specifically, the “do-what” field 148 can include an assortment of interface input mechanisms (not shown), such as various graphical knobs, sliding bars, text entry fields, etc. (In addition, or in the alternative, the input mechanisms can include other kinds of input devices, such as voice recognition devices, motion detection devices, various kinds of biometric input devices, various kinds of biofeedback input devices, and so on.) The business 102 includes a communication path 150 for forwarding instructions generated by the “do-what” commands to the processes (106, 108, . . . 110). Such communication path 150 can be implemented as a digital network communication path, such as the Internet, an intranet within a business enterprise 102, a LAN network, etc. In one embodiment, the communication path 130 and communication path 150 can be implemented as the same digital network.

Referring to FIG. 3 again, in another embodiment, the input mechanisms (318, 320, 322, 324) provided in window 316 can be used to enter “do-what” commands. As described above, the “do-what” commands can reflect decisions made by the cockpit user 138 based on his or her business judgment, that, in turn, can reflect the cockpit user's business experience. Alternatively, the “do-what” commands may be based on insight gained by running one or more “what-if” scenarios. As will be described, the cockpit user 138 can manually initiate these “what-if” scenarios or can rely, in whole or in part, on automated algorithms provided by the digital cockpit 104 to sequence through a number of “what-if” scenarios using an optimization strategy. As explained above, the digital cockpit 104 propagates instructions based on the “do-what” commands to different target processes (106, 108, . . . 110) in the business 102 to affect specified changes in the business 102.

In operation, “what-if” or “do-what” scenario building involves selecting a set of input assumptions, such as a particular combination of X variables associated with a set of input parameters provided on the cockpit interface 134 in a number of predetermined scenarios. Moreover, “what-if” or “do-what” scenario building involves generating predictions (step 518) based on various input assumptions using the transfer functions, which provide one, or more output variable(s) Y. In one embodiment, there are multiple techniques to generate the output variable Y, such as Monte Carlo simulation techniques, discrete event simulation techniques, continuous simulation techniques, and other kinds of techniques using transfer functions to run different case computations. These computations may involve sampling probabilistic input assumptions in order to provide probabilistic output results. In this context, the method 500 entails combining and organizing the output results associated with different cases and making the collated output probability distribution available for downstream optimization and decisioning operations.

In yet another embodiment, the method 500 includes analyzing whether the output result satisfies various criteria. For instance, comparing the output result with predetermined threshold values, or comparing a current output result with a previous output result provided in a previous iteration of the loop shown in the “what-if” or “do-what” scenarios. Based on the determination criterion, the method 500 may decide that a satisfactory result has not been achieved by the digital cockpit 104. In this case, the method 500 returns to step 502 and 503, where a different permutation of input parameters is selected, followed by a repetition of steps 504, 505, and 513. This thus-defined loop is repeated until steps 515 and 516 determine that one or more satisfactory results have been generated by the method 500 (e.g., as reflected by the result satisfying various predetermined criteria). Described in more general terms, the loop defined by steps 502, 503, 504, 505, 513, 515 and 516 seek to determine the “best” permutation of input parameters, where “best” is determined by a predetermined criterion (or criteria).

Various considerations can be used in sequencing through input considerations in step 505 and its sub-steps 506, 507, 508, 509 and 510 of FIG. 5. Assume, for example, that in a particular instance, a transfer function of the digital cockpit 104 is built using a technique 506 that maps a predetermined number of actionable X variables into one or more Y variables. In this case, the method 500 can parametrically vary each one of these X variables while, in turn, keeping the others constant, and then examining the output result for each permutation. In another example, the digital cockpit 104 may use another technique 510 and can provide more complex procedures for changing the groups of X variables at the same time. Further, in yet another instance, the digital cockpit 104 can deploy a variety of automated tools for implementing the operations performed as in step 512. In another implementation, the digital cockpit 104 an deploy various types of rule-based engine techniques, statistical analysis techniques, expert system analysis techniques, neural network techniques, gradient search techniques, etc. to help make appropriate decisions regarding an appropriate manner for changing X variables (separately or at the same time). For instance, there may be empirical business knowledge in a particular business sector that has a bearing on what input assumptions should be tested. This empirical knowledge can be factored into one or more of the steps 506, 507, 508, 509 and 510 using the above-described rule-based logic or expert systems analysis, etc.

An assumption was made in the above discussion that the cockpit user 138 manually changes the input parameters in the cockpit interface 134 primarily based on his or her business judgment. That is, the cockpit user 138 manually selects a desired permutation of input settings, observes the result on the cockpit interface 134, and then selects another permutation of input settings, and so on. However, in another embodiment, the digital cockpit 104 can automate this trial and error approach by automatically sequencing through a series of input settings (step 512). Such automation was introduced in the context of step 428 of FIG. 4.

In one embodiment, an automated optimization routine 428 can be manually initiated by the cockpit user 138, for example, by entering various commands into the cockpit interface 134. In another embodiment, the automated optimization routine 428 can be automatically triggered in response to predefined events. For instance, the automated optimization routine 428 can be automatically triggered if various events occur within the business 102, as reflected by collected data stored in the data warehouses 208 (such as the event of the collected data exceeding or falling below a predefined threshold). Alternatively, the analysis shown in FIG. 4 can be performed at periodic scheduled times in automated fashion. The algorithms used in this embodiment to build the system, sub-system and the component transfer functions ensure that the systems and its sub-system and the component respond to the requests of the automatic scenario generation in a manner expected.

To elaborate further the automatic transfer function building application, reference is made again to FIG. 1. In FIG. 1, the cockpit control module 132 can include functionality for automatically analyzing information received from the processes (106, 108, . . . 110), and then automatically generating “what-if” and “do-what” commands for dissemination to appropriate target resources within the processes (106, 108, . . . 110). Such automatic control can include mapping various input conditions to various instructions to be propagated into the processes (106, 108, . . . 110). Such automatic control of the business 102 can therefore be likened to an automatic pilot provided by a vehicle. In yet another embodiment, the cockpit control module 132 generates a series of recommendations regarding different courses of actions that the cockpit user 138 might take, and the cockpit user 138 exercises human judgment in selecting a control strategy from among the recommendations (or in selecting a strategy that is not included in the recommendations).

In yet another implementation of the automatic transfer function building functionality as illustrated in FIG. 2, the analysis logic 222 can include a number of other modules for performing analysis, although not specifically identified in FIG. 2. For instance, the analysis logic 222 can include logic for automatically selecting an appropriate model (or models) 136 to run based on the cockpit user's 138 current needs. For instance, empirical data can be stored which defines which transfer functions have been useful in the past for successfully answering various queries specified by the cockpit user 138. This module can use this empirical data to automatically select an appropriate transfer function for use in addressing the cockpit user's 138 current needs (as reflected by the current query input by the cockpit user 138, as well as other information regarding the requested analysis). Alternatively, the cockpit user 138 can manually select one or more transfer function(s) to address an input case scenario. In like fashion, when the digital cockpit 104 operates in its automatic mode, the analysis logic 222 can use automated or manual techniques to select transfer function(s) to run.

As part of the automatic transfer function building scenario, in yet another embodiment, the digital cockpit 104 utilizes the transfer functions to model and monitor the business in “real time” or “near real time” manner. In this embodiment, the digital cockpit 104 receives information from the business 102 and forwards instructions to the business 102 in real time or near real time. Further, if configured to run in an automatic mode, the digital cockpit 104 automatically analyzes the collected data using one or more transfer function(s) and then forwards instructions to processes (106, 108, . . . 110) in real time or near real time. In this manner, the digital cockpit 104 can translate changes that occur within the processes (106, 108, . . . 110) to appropriate corrective action transmitted to the processes (106, 108, . . . 110) in real time or near real time in a manner analogous to an auto-pilot of a moving vehicle. In the context used here, “near real time” generally refers to a time period that is sufficient timely to steer the business 102 along a desired path, without incurring significant deviations from this desired path. Accordingly, the term “near real time” will depend on the specific business environment in which the digital cockpit 104 is deployed; in one exemplary embodiment, “near real time” can refer to a delay of several seconds, several minutes, etc. Like in the previous examples, the algorithms used in this embodiment to build the system, sub-system and the component transfer functions ensure that the systems and its sub-system and the component respond to the need of “real time” or “near real time” scenario generation in a manner expected.

Referring back to FIG. 5, at steps 514, 515 and 516 and all the related iterations, eventually the digital cockpit 104 arrives at one or more input case assumptions (e.g., combinations of actionable and non-actionable X variables) that satisfy the stated criteria. At this point of time the resulting transfer function(s) is (are) accepted as final solution(s) and it (these) is (are) applied in different business contexts as in step 517 to achieve different functionalities.

For instance, in one embodiment, the step 518 involves prediction and consolidation of the output results generated by the digital cockpit 104. Such prediction and consolidation may include generating a number of output parameters for various input parameters, organizing the output results into groups, eliminating certain solutions and finally arriving at an optimized set of predicted values. Step 518 may also extend into codifying the output results for storage to enable the output results to be retrieved at a later point in time as described in relation to step 520 later.

In another embodiment, all the information in relation to the transfer functions are fed back into the components responsible for selection of different parameters and thereby overall control of the system as in step 519. Referring to FIG. 1, the steering control interface 152 typically represents one such control mechanism, the cockpit user 138 may use to make changes to the business processes (106, 108, . . . 110), whether these changes are made via the “do-what” field 148 of the cockpit interface 134, via conventional and manual routes, or via automated process control using the transfer functions. To continue with the metaphor of a physical cockpit, the steering control interface 152 is analogous to a steering stick used in an airplane cockpit to steer the airplane, where such a steering stick may be controlled by the cockpit user by entering commands through a graphical user interface. Alternatively, the steering stick can be manually controlled by the user, or automatically controlled by an “auto-pilot.”

According to yet another exemplary embodiment, the described method for building transfer functions is capable of generating pre-calculation of output results for presentation in a digital cockpit at a later point of time as in step 520. In this embodiment, the method generates a set of output results using a business model, where the generating of the set of output results is performed prior to a request by a user for the output results. The output results are then stored for future reproduction and use. More specifically, as discussed in connection with FIG. 4, in one implementation, the digital cockpit 104 can archive the output results such that these results can be recalled upon the request of the cockpit user 138 without incurring the time delay required to recalculate the output results. The digital cockpit can also store information regarding different versions of the output results, information regarding the user who created the results, as well as other accounting-type information used to manage the output results. Later, on receiving a user's request for an output result via the digital cockpit, the system determines whether the requested output result has been generated in advance of the user's request and if the requested output result has been generated in advance, the requested output result are retrieved from storage and presented to the user through the display part of the user interface.

Application of the transfer functions to build different functionalities as explained above are the steps that lead finally to testing and validating of the transfer functions as in step 521 of FIG. 5. One of the many ways to test and validate a transfer function is to measure the accuracy of the forecasts made by the transfer function. This is illustrated in FIG. 6. In general, as mentioned above, the presentations shown in FIG. 6 can provide information regarding prior (i.e., historical) periods of time. More specifically, consider the exemplary case of FIG. 6, which shows increasing uncertainty associated with output results by varying the density level of the output results. Assume that time slice 602 reflects the time at which the cockpit user 138 requested the digital cockpit 104 to generate the forecast shown in FIG. 6, that is, the prevailing present time when cockpit user 138 made the request. Assume that time slice 606 represents a future time relative to the time of the cockpit user's 138 request, such as six months after the time at which the output forecast was requested. Subsequent to the generation of this projection, the actual course that the business takes “into the future” can be mapped on the presentation shown in FIG. 6, for instance, by superimposing the actually measured metrics on the presentation shown in FIG. 6. This will allow the cockpit user 138 to gauge the accuracy of the forecast originally generated at time slice 602. For instance, when the time corresponding to time slice 606 actually arrives, the cockpit user 138 can superimpose a response surface, which illustrates what actually happened relative to what was projected to happen.

According to yet another exemplary embodiment, the digital cockpit 104 may include a user interface to provide access to a control module of the digital cockpit 104. Typically, the control module of the digital cockpit 104 is configured to receive information provided by business processes in relation to a number of input parameters associated with one or more of the resources used in the business and at least one output parameter associated with the operation of the business and configured to generate a number of mathematical or algorithmic business system transfer functions.

The user interface typically includes a primary display layer that presents a testbed environment for the business information and decisioning control system. The primary display layer is constructed to present a stochastic simulation of the output parameter(s) based on the mathematical or algorithmic transfer functions. The transfer functions for relatively complex systems may be modeled using dynamic algorithmic simulation models and displayed in a primary display layer. The stochastic testbed environment is built to model and describe the behavior of a real-life business system. The models displayed and tested on the primary display layer then help in making suitable decisions about the business system.

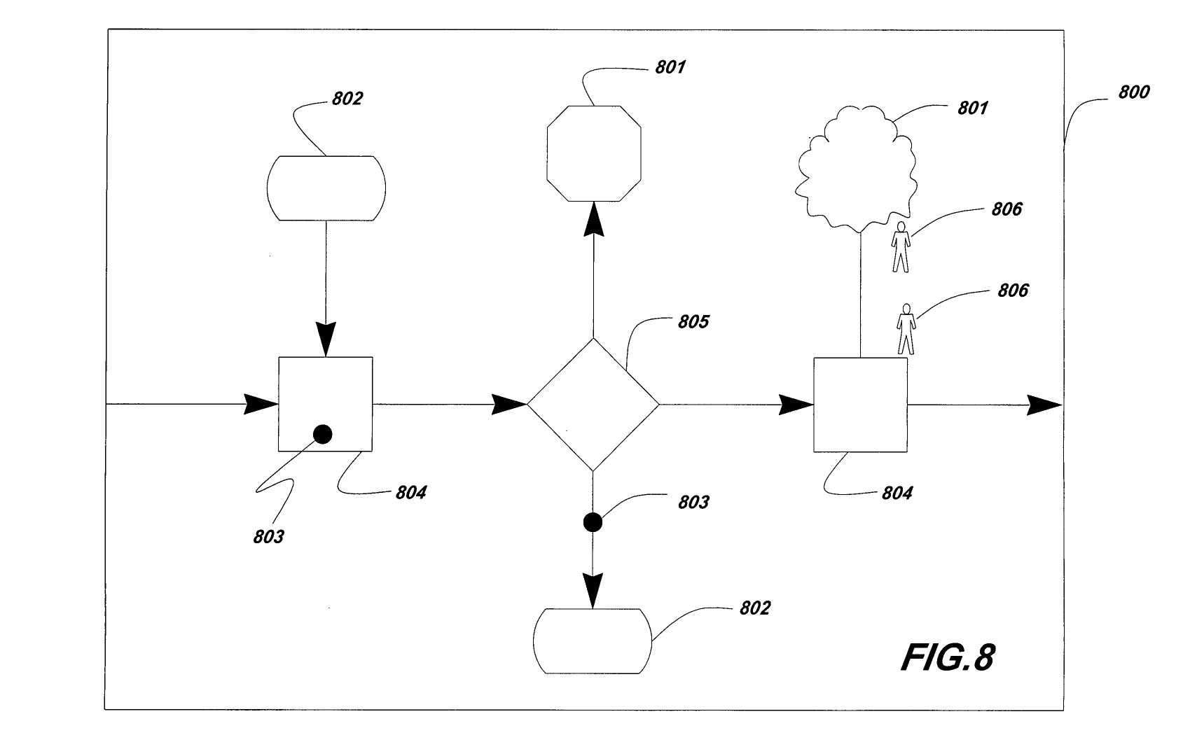

FIG. 8 illustrates an exemplary primary display layer 800 used to represent a testbed environment for stochastic simulation of relevant transfer functions. The primary display layer 800 primarily relates to animated visualization of various business objects, their behavior and also display of a number of statistics related to the business objects and the related transfer functions. Referring to FIG. 8, element 801 shows examples of statistics collected at the system level over a certain period of time. Elements 802 point to examples of information and statistics on significant subsystem level process stages such as business tollgates. Elements 803 represent two exemplary dynamically colored visual entities, each representing a stage of progress of an exemplary business ‘deal’ flowing through the simulation of the business system. In general, the primary display layer represents the underlying process being simulated, and corresponds to the state of the simulation being performed. The primary display layer provides a description or visualization of the simulated process.

To elaborate further, a financing decision for a specific ‘deal’ in an asset financing business may be an example of a business systems and process being simulated for making a number of decisions. In this exemplary financing decision situation, a decision maker in an asset financing business takes a customer's financial information, asset information, proposed structure of financing and other information to arrive at a yes/no decision as to financing a specific deal. In that context, a deal signifies a transaction that requires a set of available initial information to be processed and a set of output decision information. For example, a fruit vendor aged 35 years with 10 years' prior experience based in a semi-urban area and applying for a business expansion credit utilizing fruit processing equipment may constitute one deal for a financing agency. Whether to finance him or not is an outcome of the asset financing decision. In the process of arriving at the final decision, various process steps such as legal assessments, risk assessments, asset valuations are performed.

Referring back to FIG. 8, the elements 804 point to two exemplary process steps that a deal has to pass through, while it is being processed in the system. Element 805 is a decision point where, according to the dynamic attributes of a deal, it may take one of the three alternative routes. Elements 806 are examples of various kinds of resources in the system, which add value at various different process steps 804 to help the deal progress forward. The dynamic business objects such as the visual entities 803 and resources 806 moving between process steps 804 are animated on the primary display layer 800 as the simulation progresses through time. To facilitate explanation, the primary display layer 800 is also referred to in the ensuing discussion by the descriptive phrases ‘animation layout’ and ‘animation window’ interchangeably. Each simulation run may take variable amounts of time depending on a number of factors having their own statistical distributions. As noted above, the primary display layer describes the operation of the business process being simulated by the testbed.

The methods and systems described herein are not limited to the specific business objects mentioned above only. In other embodiments, there may be other business objects taken up for simulation such as different types of users, a database, another simulation, or an intelligent decision-making application, or a combination of the above. The ground rule however followed in all such instances is that the display and other behavioral properties of the business objects are to be modeled in the simulation progressing on the primary display layer 800.

Furthermore, the primary display layer 800 may adjust itself depending on what level of detail of the animation is being channeled out. In one embodiment, the animation may be slow and rich with relatively more graphical details. In another embodiment, the animation may be fast and showing only minimal necessary statistics. In such cases, typically there is no need to continuously display the animation layout since that may tend to appear like a static picture. The need however may be to display relevant statistical charts and tables and to update them frequently.

Although the present methods and systems are described with reference to a simulation based primary display layer 800 of a testbed environment, the principles associated with them are not limited to only one of such primary display layers. Once the simulation testbed environment is in place, there are several other embodiments possible. In one embodiment, the simulation in the primary display layer 800 is run without a cockpit-like graphical user interface (GUII). In such an embodiment, the simulation model is not an interactive model and most of the input may be provided through an input data file, for instance. This may limit the ability of a typical user to interact with the models both before and during the simulation run, especially if the models are simulated on a platform that the user is not very familiar with. In another embodiment, where the application is in gaming-like educational environments, or is used to train people within a combined automated/manual decision-making setting, it may be difficult or may need additional computational resources to build all the desired models.

In one embodiment, the simulation represented in the primary display layer 800 may be controlled by a cockpit-like GUI external to the simulation engine. This is especially desirable for platforms that do not provide any means of platform-native support for modern graphical user interfaces, and therefore depend on external inputs for control. While the simulation model in this embodiment specializes only on simulating the operation of the business system, the runtime interactive GUI may be functionally delegated to a decoupled module attached to the simulation engine.

Thus, the external cockpits mentioned above are typically command and control cockpits that form the interface between the primary display layer 800 or the transfer function and a human decision maker and/or other auto-decisioning agents. In one embodiment, the external cockpit is structurally decoupled from the primary display layer 800 or the transfer function. The decoupled external cockpit takes on the responsibility of monitoring, interacting with, and decisioning for the simulation presented on the primary display layer 800 by allowing interaction by a decision-making human being. The cockpit is considered ‘decoupled’ because it is not an integral part of the simulation test bed itself, and is not part of the display of the simulation testbed or its primary display layer. Instead, the cockpit is configured to accept output from the simulation, and to pass control parameters into the simulation. By making the cockpit a separate process, it can be started, stopped, displayed, and configured independently of the underlying simulation testbed.

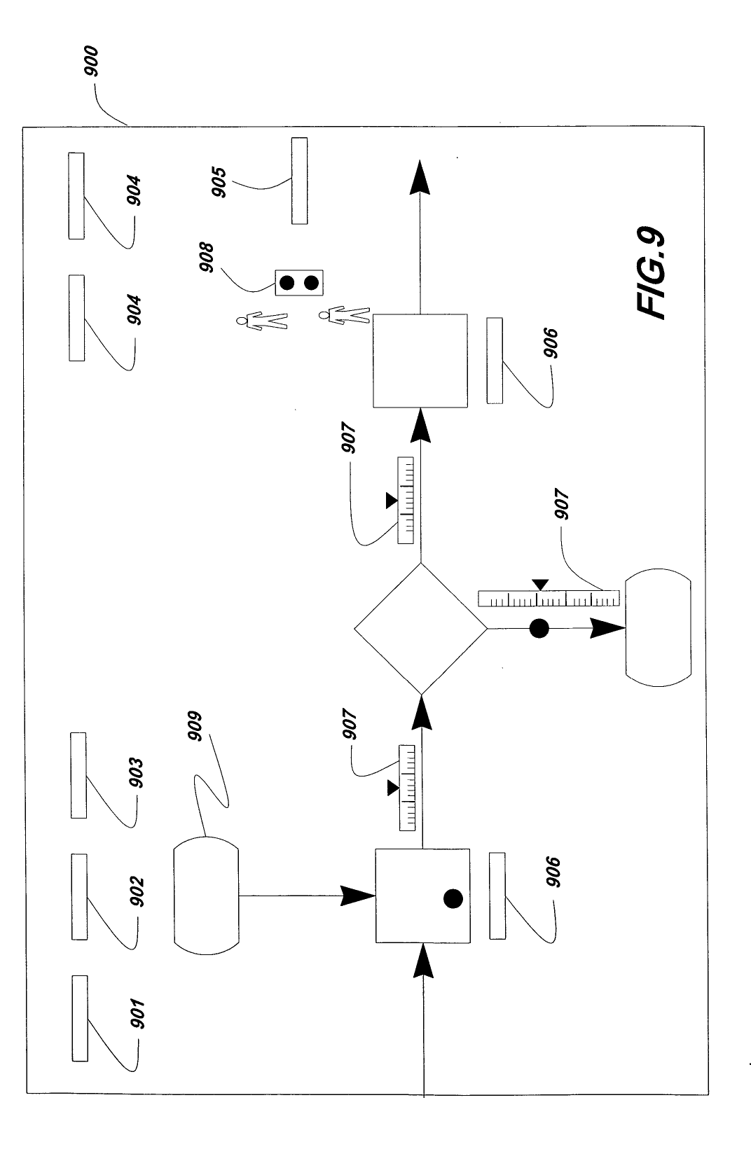

FIG. 9 shows an exemplary embodiment of one such visual cockpit 900 with various interactive components overlaid on the primary display layer of FIG. 8. Many of the interactive components correspond to the simulation or animation layout of the primary display layer 800 of FIG. 8 in a simplified or symbolic way, and are presented in a manner interlaced with the simulation layout. Components labeled 901 to 903 in FIG. 9 are main menu components to interact with administrative functions of the external visual cockpit 900, such as programmatic connection with the platform that supports the stochastic testbed environment, change between various instances of the testbed model, start running the testbed model in various forms or pause or stop it, connect into other programmatic decisioning agents, configure their mode of operation, start acting as a programmatic bridge between such decisioning agents and the stochastic model, sensitivity analysis related settings, etc.

Referring to FIG. 9 again, elements 902 govern parameter settings associated with the simulation. Elements 903 contain some more options that the user could interact with, dynamically participating in stochastic simulation. Control buttons 904 allow further administrative configuration of the cockpit, such as turning the simulation on the primary display layer on or off, or making the external visual cockpit 900 appear as a stand-alone, traditional window versus a transparent mask that is interlaced with the simulation over the primary display layer 800 of FIG. 8, as will be discussed below. In structure, the visual cockpit layout 900 may include various graphical, textual or click-and-drag input mechanism to receive input from a user.

Continuing with the exemplary external visual cockpit 900 presented in FIG. 9, interactive components such as control buttons 905 allow a user to incorporate behavioral changes on the resources in the model. These controls can be used to command changes in the parameters governing the operation of the simulated process. For example, by interacting with one such control button 905, simulated sales persons can be made to spend more time generating new leads as opposed to working on old leads already collected through various activities. Other controls such as elements 906 allow a typical decision maker to use the digital cockpit 104 to control variable yet controllable parameters such as time span of various activity steps, variability of the random distributions and the like. Yet other controls such as 907 allow a typical user of the digital cockpit 104 to introduce new routing patterns and probabilities into the system. For instance, a cockpit user may simulate the effects of increasing or decreasing financial losses in the system through interacting with these controls. Element 908 are controls that allow a cockpit user to change the behavior and likelihood of complex actions in the models such as referrals to other human resources with different skills and optional/extra steps. Through the use of these controls, the operator may introduce changes into the simulation being run on the testbed and observe the response to these changes in the primary display of the simulation.

While it is possible that the primary display layer 800 of FIG. 8 is positioned as a separate visual component than the visual cockpit, there are benefits accruing from interlacing or overlaying the descriptive elements of the animation layout 800 with the control elements of the visual cockpit. To be effective, it may be advantageous to make the visual cockpit at least symbolically similar to the animation layout 800 so that a user may be able to orient himself easily between the two layouts for related references. As shown in the embodiment in FIG. 9, control elements 906, 907, 908 may be located in positions that correspond to the underlying simulated structure of the business process, illustrated in FIG. 8. However, the control cockpit is a separate display layer, decoupled from the testbed, presenting a way for a user to prescriptively command the simulation.

In one exemplary instance, a high-level workflow simulation model can be controlled using the external cockpit graphical user interface 900 of FIG. 9. Through the various command and control options mentioned above, a user may introduce changes in the primary parameters that drive the behavior of the models, and dynamically visualize different ‘what-if’ scenarios that affect the behavior of the system. Examples of such ‘what-if’ scenarios in a typical sales and marketing organizational system may include simulating various staffing levels for various kinds of resources on the animation layout 800 and the checking for their impact on the output levels of the system, simulating mobilization of additional sales support resources and their effectiveness in reducing the workload of core sales workforce, simulating and visualizing how various resources distribute their time over various types of activities and the like.

To facilitate the interaction of the user with the animation layout 800 using the visual cockpit 900, in one embodiment, there may be two completely separate screens showing the animation layout and visual cockpit. In another embodiment of the user interface, the visual cockpit may overlap and partially cover the animation layout as shown in FIG. 9. Overlapping the primary display layer and the cockpit layer helps to avoid wasted screen real estate allows a user to dedicate most of the available screen resolution towards seeing a larger part of the animation and statistics with more detail, eliminating the need to switch back and forth between a separately displayed control cockpit and descriptive simulation display.

The embodiments described here provide a variable transparency or translucency for the layers placed over the primary display of the simulation. This allows effective visibility of the descriptive power of the primary display layer while still providing access to the controls available through the cockpit. As models get more visually complex and interactive, effective use of screen real estate becomes increasingly important, especially when the models are meant to run in animated mode. The usable screen space is used wisely and designed to be collaborative between areas set aside for animation, primary performance measures or other statistics, vis-à-vis the interactive controls on a cockpit that are used for parameter calibration or decision-making throughout the simulation. In one embodiment, the solution implemented is to superimpose the interactive external visual cockpit over the primary display layer 800 of FIG. 8 to command and control the testbed simulation environment. In addition, translucent masks that are interlaced with the primary display layer 800 may be used to facilitate high utilization of the computer screen while providing a meaningful GUI that fits well within the context of the semantic and/or physical system being modeled.

An interactive mask is defined as a translucent overlay embedded with some controls on it to receive inputs from a user. To provide an interface between the transfer function or the simulation model that acts as the testbed environment and a user, an interactive mask is overlaid on the primary display layer 800. This mask is semi-transparent most of the time and/or in most regions over a computer screen except for those that are sensitive to user-interaction. These sensitive user-interaction zones may be called interaction zones on the computer screen. Over these interaction zones, a user may typically be able to interact with the visual cockpit and still follow the animation and statistics of the simulation on the animation layout 800 by seeing through the mask.

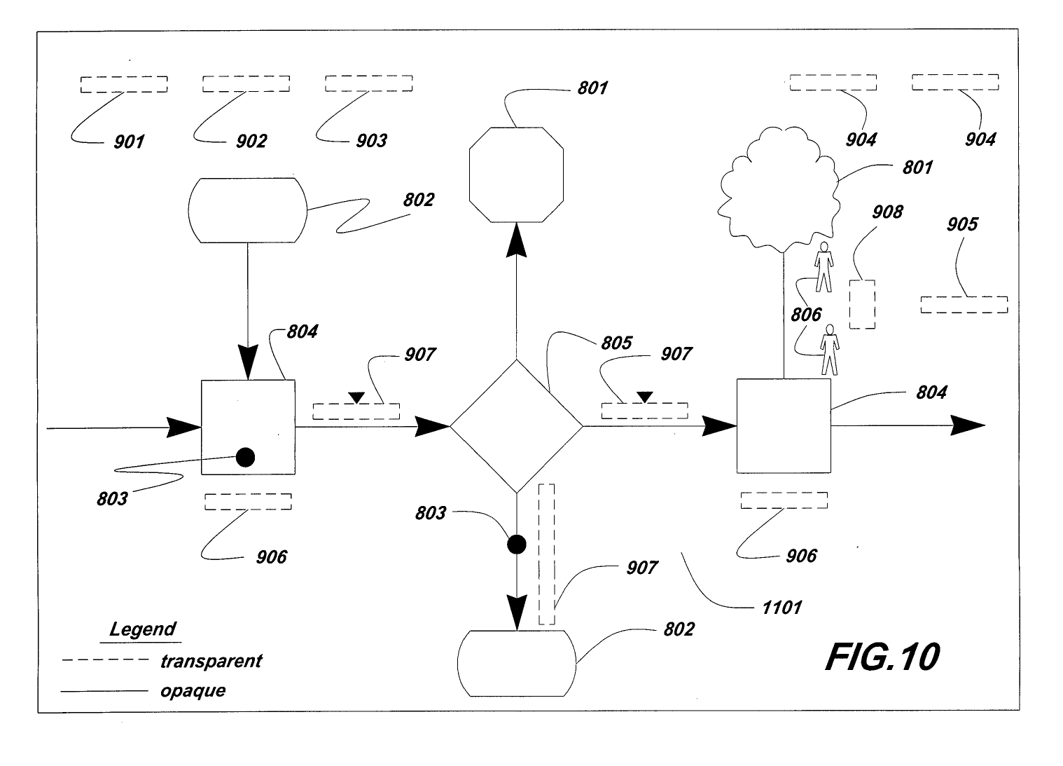

FIG. 10 shows an embodiment of the interface where an integrated layout of the user interface of the digital cockpit 104 is presented to a user. In this integrated layout of the user interface, the visual cockpit layout is interlaced and superimposed over the animation layout 800. The visual cockpit allows a maximum amount of visibility of the animation layout 800 in the background through itself. FIG. 10 shows the visual cockpit 900 in a state when the user has turned a ‘mostly transparent’ control mode on. Components in FIG. 10 that are identical to components shown in FIG. 8 and FIG. 9 are identified using the same reference numerals used in FIG. 8 and FIG. 9. The visual cockpit 900 in this example is sensitive to user actions in its visibility/transparency level. While the user is observing the simulation with no current intentions to intervene, the most part of the visual cockpit is inactive and hence less visible/noticeable so as to allow the animation and statistics on the animation layout 800 to take the main stage.

The degree of transparency, translucency and opaqueness or in other words the state of visibility of a part or whole of an interactive mask is adaptable and adjustable depending upon user preferences. In one embodiment, the entire cockpit window is mostly kept transparent, for instance, with 80% transparency level, thereby enabling the user to be visually aware that there is a visual cockpit layer superimposed on the opaque animation layout 800. The user also comes to know intuitively or through explicit instructions that he can make the visual cockpit layer active or let it come alive by being less transparent when the user is moving the mouse over the areas that are sensitive to interaction.

In another embodiment, any other combinations of partial or complete translucent settings, or selective see-through areas, with either the entire cockpit or individual controls may be chosen. In essence, the visual cockpit layer becomes more visible (less transparent) when the user actually desires to interact with the model, but becomes more transparent at other times, allowing the animation layout 800 in the background to display the performance measures. For instance, when a user wants to view any ongoing animation aspect related to the resources 806 of FIG. 8, the visual cockpit layer 900 remains transparent or translucent.

At another time, when the user actually desires to interact with the model and incorporate behavioral changes on the resources 806, he may move his computer mouse or a similar input device to the vicinity of the display of the resources 806. In another instance, the user may click his mouse or similar input device in the vicinity of the display of the resources 806. In response, the visual cockpit layer 900 becomes active, turning less transparent, and the controls 905 and 908 become ready to receive inputs.

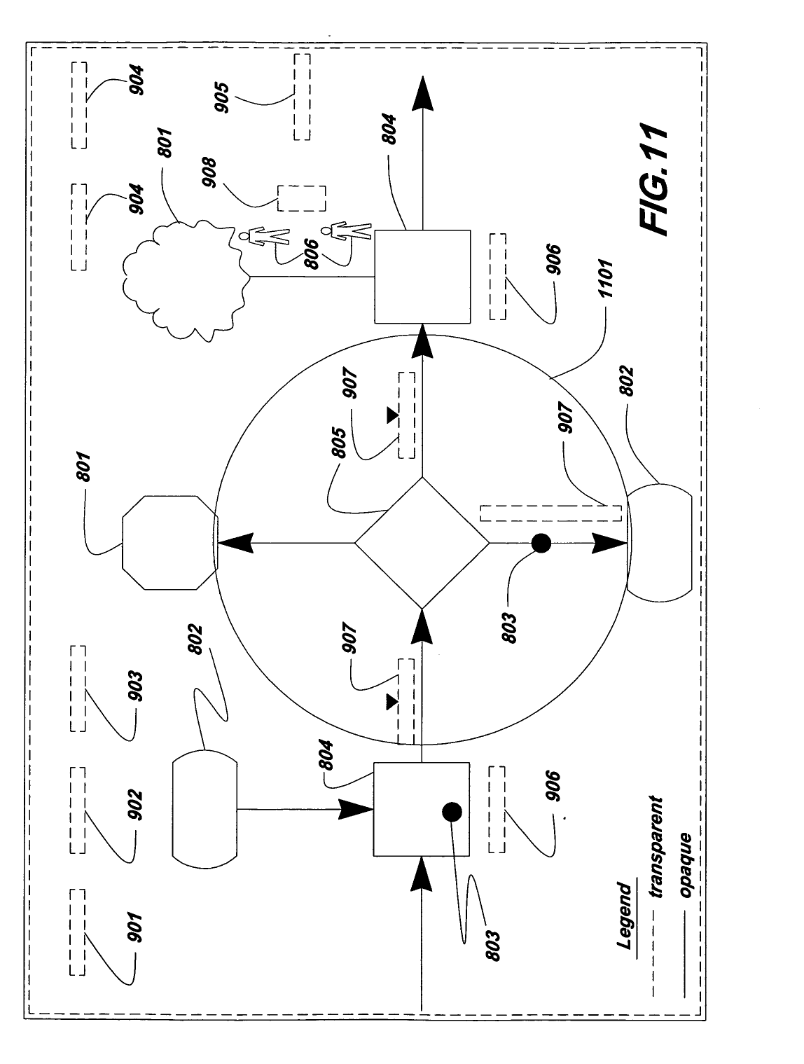

FIG. 11 shows a partially translucent visual cockpit 900 that is sensitive to user actions in its visibility/transparency level. This figure is an instance of the visual cockpit 900 being partially active, for example, when the user positions the mouse over one chose area of the screen. The visual cockpit 900 allows a maximum amount of visibility of the animation layout 800 in the background through itself. Components in FIG. 11 that are identical to components in FIG. 10 are identified using the same reference numerals used in FIG. 10. As is evident, FIG. 11 is same as FIG. 10 in all aspects except the introduction of an interaction zone 101 marked in FIG. 11 in a circle. Some of the controls such as 907 falling within the interaction zone 1101 have become active and come alive by becoming more opaque and hence more visible. However, the other non-interactive areas of the visual cockpit 900 are still transparent, allowing the user to see through to the background. The visual cockpit 900 in this example is partially sensitive to user actions in its visibility/transparency level. While the user is observing the simulation with selective interaction, the most part of the visual cockpit 900 except the interactive zone 101 is inactive and hence less visible/noticeable so as to allow the animation and statistics on the animation layout 800 to be displayed without obstruction.

In another embodiment, only the interactive zones including the relevant interactive controls such as the buttons, levers, and input fields may be kept opaque and the rest of the background may be rendered transparent. This allows the controls on the visual cockpit 800 to be identifiable, yet the rest of the animation layout 800 remains largely unobstructed. In yet another embodiment, the entire cockpit window and all of the controls are kept virtually invisible until a user-event triggers an action to do otherwise. This allows the entire model animation to be unobstructed most of the time, while allowing for clear means of interaction. Note that the interactive zone need not be circular, and will not normally be indicated by a visible border in the display. The controls within the interactive zone will simply become more opaque in order to indicate their availability to the user.

In different embodiments presented above, there are many ways to display a particular simulation depending on the level of detail and aspect of focus desired. In a like manner, there are also multiple ways to command and control a given testbed environment. These different command schemes are referred to as “control scenarios” of a simulation. Regardless of the translucency and overlay options for the GUI, the interface design and functionality of the cockpit change with respect to the kind of analysis being performed and the aspects of the simulation being controlled. Typically such aspects of the simulation may include time-crunching activity durations vis-à-vis resource allocation rules vs. staffing levels vs. cost sensitivity vs. decision algorithmic vs. market conditions, etc. In another embodiment, the interface design and functionality of the cockpit may depend on several other factors. These factors may include the level of detail of the animation desired, the type of the user or the use-cases or the points of view into the system. In other instances, the interface design and functionality of the cockpit may depend on availability of any external decision-making agents other than the user who is directly interfacing with this particular mask such as an automated decision engines, other users and the like. Each variation of the masks that provide different access or behavior of the cockpit display represents a different control scenario.

In operationalizing the concept of control scenarios, the translucent mask(s) overlaid with the animation layout 800 play an important role in alternating between various alternative control scenarios without modifying on the underlying simulation testbed platform. As an illustration, when interacting with a particular simulation situation, a user may typically make a choice about what control(s) may come alive and become more dominant. In one embodiment, various control configurations may include only the controls that are being interacted with. In another embodiment, various control configurations may include the controls that are being interacted with and a few others that are notionally or semantically related. In another embodiment, various configurations may include all controls that could possibly be interacted with. The choice will depend on whether the users would desire/prefer to have a visual reminder of what semantic relationships exist between various alternative controls vs. being more interested in minimizing layout clutter.

Every viable combination of the above factors constitutes a simulation control scenario. Each control scenarios results in customized behavior of the visual cockpit due to the differences in the way the user may interact with the underlying simulation. Ideally, different masks, or at least different variations around some key themes, are placed over the animation layout 800 in such a way that the relevant subset of active controls are interlaced with the semantically related areas of the visual cockpit 900. ‘Semantically related’ controls are those that address the same or related functions or activities within the simulation testbed.

The translucent mask(s) as mentioned above when placed over the layout of the animated simulation model enables the user to chose among various alternative menus representing various control scenarios without having to modify the underlying simulation model.

In a typical example, various alternative ways of making the same decision may be illustrated through the use of translucent masks and external decision making agents, under four different control scenarios, each discussed further below. The context here is one of the stages that financial deals flow through in an organization while they are progressing along the workflow. The process in this example may be called “Create Financial Solution” (CFS) process. Typically, CFS includes complex and labor-intensive operations, where up to five different kinds of resources may evaluate the data that has been collected on that deal in previous stages, and decide how to structure a financing proposal, or even whether to submit a proposal or not. In addition to the overall dynamic/runtime calibration facilities that the visual cockpit 900 provides, a user can typically also choose between four modes while running the simulation with respect to doing short-circuit risk-evaluation for a deal as part of the CFS activity. The four modes may be structured such that they are graded over an increasing order of intelligence introduced in the user interface using different combinations of controls or in other four different control scenarios. The four different control scenarios show the exact same area of the system, but offer four different combinations of the controls on the visual cockpit layout 900. The screen design and interactive components used to input decisions from the user are dependent on the details of the scenario that is active at any point of time.

A first exemplary instance of the CFS simulation may be a traditional decision-making (DM) mode where no short-circuit risk-evaluation is made and all throughput is routed internal to the testbed environment, in a relatively unsophisticated fashion. In this instance, there is no user interaction required, and no additional decision control buttons show up in the visual cockpit 900 overlaying the animation layout 800.

A second exemplary instance of the CFS simulation may be a stepwise user-DM mode where a user is presented with the details of each deal and asked to make a decision about it. In this case, the user is allowed to choose among a few alternative ways to treat a particular deal such as ‘skip this step due to this particular deal being found as not risky’, ‘go through the usual labor-intensive process due to the risk-evaluation process on this deal being inconclusive in either direction’, or ‘immediately drop this deal due to it being found as too risky’ and the like.

A third exemplary instance of the CFS simulation may be a stepwise mode where an external programmatic DM agent is brought in to automatically make the risk-evaluation decisions, and a user can observe the decision-making process for each deal before proceeding with the run. In this case, the user is allowed to step through individual decisions, but not allowed to make manual decisions or change the decisions made. In this instance, the user is merely allowed to observe in detail the simulation going on in the system. He typically is presented with a control button to proceed with the acceptance and execution of the decisions made by an external auto-decisioning agent.

A fourth exemplary instance of the CFS simulation may be an auto-decisioning mode where the same external programmatic DM agent makes and continually introduces the decisions into the model, without waiting for any kind of interaction from the user. In this case too there is no user interaction required, so no additional decision control buttons show up in the visual cockpit 900 overlaying the animation layout 800.

In another embodiment, translucent masks and control scenarios are utilized to enable layers of intelligent agents to be stacked on top of each other. In one such embodiment, the bottom most layer is typically limited to describing the behavior of the system and it does not contain any sophistication in terms of decision-making algorithms. Layers that are built on top of the bottom most layer that are increasingly intelligent in terms of functionalities for detection and correction of certain situations in the testbed, automatic decisioning, as well as a high-level wing-to-wing command and control.

In another embodiment the concepts of control scenarios and translucent masks are further leveraged such that the increasing order of intelligence can be stratified over a number of display layers of intelligent agents stacked on top of each other. In the embodiments presented above in FIGS. 8 to 11, only two display layers (the primary display layer 800 for the simulation and the control cockpit) of the user interface have been described. In other embodiments however there may be multiple intermediate layers inserted between the primary display layer 800 and the visual cockpit layer.

For instance, in one embodiment, the business system user interface may include at least one secondary display layer that presents interpretation of at least one of signals, trends, warning and conclusions generated by the primary display layer. Such a secondary display layer may show aggregated or interpretive output. Such a layer will also be referred to as a “monitoring” layer. While such a layer has an essentially descriptive function, the information presented represents an analysis of the lower level simulation output data. As with the control cockpit described above, such a monitoring layer may preferably be decoupled from the underlying testbed. The display of the monitoring layer may be located at a position relevant to the appropriate supporting data in the primary display layer, so as to provide a visual link between the summary or interpretive information presented in the secondary display layer, and the portion of the primary display layer associated with the supporting data. For example, a secondary display layer associated with the costs associated with personnel might be overlaid on the primary display layer at a location associated with the operation of that personnel. However, it should be understood that such a secondary display layer need not be presented as an overlay. The various transparency techniques discussed herein with respect to the control cockpit layer may also be applied to the secondary layer.

In yet another embodiment, the business system user interface may further include a tertiary display layer that presents a number of suggested business decisions developed based on the signals, trends, warning and conclusions generated by the primary display layer or the interpretation presented by the at least one secondary display layer. Such a decisioning layer may have the authority to exert some level of control over the underlying simulation by altering certain control parameters of the testbed simulation in response to the output received by the decisioning layer from the testbed. However, decisioning layers may also be configured simply to suggest possible control changes in response to the information that they receive, and leave the choice of whether or not to implement those control changes to the user. The user would be free to implement such changes via the control cockpit as discussed above. As with the secondary display layer, the tertiary or decisioning layer may also be located as an overlay at an appropriate position over the primary display layer, and may have the various transparency properties described herein. Alternatively, the decisioning layers (also referred to as decisioning agents) need not be visually displayed at all.

It is evident that in a multiple layer configuration of the testbed environment as presented above, the masks placed on top of the primary display layer 800 may play an important role in alternating between various control scenarios without making any modifications on the underlying simulation testbed platform. When dealing with intricate systems surrounded by complex decision analytics, one such system may tend to be functionally polarized between two extreme functional possibilities. One such exemplary function is simulating the system in a stochastic fashion to describe the random effects, time dependency and dynamic interactions among components. The second exemplary function is making decisions to drive, optimize, correct the system, recover from disasters, or taking proactive action to make the system more robust to a spectrum of possible future states.

In another embodiment, there may more than two display layers. In one such embodiment, there may be an exemplary bottom-most level that is purely descriptive. In contrast, there may be a top most layer that is prescriptive or decision suggesting in nature. One such layer may typically include a control cockpit. In addition to these two layers, there may be a number of intermediate layers arranged between the bottom most and the top most layer mentioned above. These intermediate layers, comprising one or more monitoring or decisioning layers, when considered from bottom to top, may have an increasing degree of prescriptive attributes such as ability for detection, ability of decision support, automatic decision making and like. The same layers, from bottom to top may have a decreasing degree of descriptive attributes.

In one such exemplary embodiment, there may be four display layers. The first primary display layer presents the simulation testbed environment, which may mostly be limited to describing the system and capturing its dynamics like the primary display layer 800 as shown in FIG. 8. In addition, there may be an intermediate secondary display layer of monitoring agents that interpret signals and deduct trends/warnings/conclusions from what is happening in the simulation testbed. Further, there may be a tertiary layer of decision-making, or at least decision-suggesting agents, based upon the indications from the layer below. Finally, there may be a fourth visual cockpit to allow the user to interactively interrupt, execute and/or change the course of the otherwise auto-piloted decisions. In other embodiments, however, the intermediate display layers may be made up of more than one layer each. For example, there may be multiple monitoring layers, each configured to respond to different output parameters of the simulation testbed.

In yet another embodiment, a relatively simple monitoring anomaly detection agent may be visualized in the form of a translucent mask that sits between the stochastic primary display layer 800 and the visual cockpit layer. In a typical exemplary simulation, visual signals on the animation layout 800 may point to the fact that due to the current settings imposed by the cockpit, the testbed environment has accumulated more than 100 business deals in its call queue. This situation may physically happen in real life when the sales resources spend a disproportionately large amount of time generating new leads as compared to a time when they are working on leads already generated. In the event of such an occurrence, the anomaly detection agent detects the anomaly and raises some visual as well as programmatic flags to be noticed by the human decision-maker as well as other auto-decisioning agents that might be active in the integrated system.

In a typical embodiment with multiple display layers, each layer can be implemented in various degrees of fidelity. Degree of fidelity of a particular layer may be understood in terms of a number of factors such as level of detail in a simulation model, flexibility of design, comprehensiveness and shades of gray for rules to raise various kinds of alarms, the complexity and elegance of an auto-decision-making optimization model and the like. In another embodiment, each layer may use various approaches, such as discrete event simulation, agent-based simulation, constraint programming, mathematical programming or heuristic optimization. In most of the different embodiments, it is possible to use a software component as a building block and if necessary, replace one with another suitable one operable at the same level, conforming to the same interfaces and without having to rewrite the rest or the whole of the system afresh.

In terms of a software architecture used to support the construction of the multiple display layers of increasing intelligence and decision supporting functions, one of the options may be to stack the layers vertically and coordinate them to deliver the desired functionalities. In addition to the stacking of the display layers presented above, in another embodiment, it is also possible to develop a network of software components such as data objects, structure, agents in a parallel or naturally segregated or disbursed manner in accordance with the semantic relationships between various areas in the testbed. Each of such various software components may focus on a different aspect of the simulation, yet may enable communication with the others in an attempt to work together and converge towards better solutions.

As such, the simulation mask described above evolves into becoming the GUI tier of such an intelligent/interactive agent, constituting a layer between the simulation engine of the digital cockpit of FIG. 1 and the end-user. This results in highly functional, intuitive and intelligent user interfaces with optimal screen real estate utilization.

A digital cockpit 104 has been described that includes a number of beneficial features, including “what-if” functionality, “do-what” functionality, the pre-calculation of output results, and the visualization of uncertainty in output results.

Although the systems and methods herein have been described in language specific to structural features and/or steps acts, it is to be understood that the invention defined in the appended claims is not necessarily limited to the specific features or steps described above. Rather, the specific features and steps disclosed above are exemplary forms of implementing the systems and methods claimed below.

What is clamed is:

1. A method for using mathematical or algorithmic business system transfer functions in support of a business information, analysis, decisioning and control system, comprising:
developing at least one business system view wherein the transfer function is configured to quantitatively express the business system view;
identifying a plurality of input parameters in the system, wherein the input parameters correspond to physical deterministic and/or probabilistic inputs to the business system in accordance with the business system view;
identifying at least one output parameter in the system, wherein the output parameters correspond to physical deterministic and/or probabilistic outputs to the business system in accordance with the business system view;
collecting operational data that associate the plurality of input parameters with the at least one output parameter based on an actual operation of the business process;
determining at least one relationship between the at least one output parameter and the plurality of input parameters based on the operational data;
mathematically and/or algorithmically describing the at least one relationship between the at least one output parameter and the plurality of input parameters using the at least one transfer function; and
displaying particular values of at least one of the plurality of input parameters, the at least one output parameters or the at least one transfer function, wherein the displaying comprises:
constructing and displaying a stochastic simulation of the at least one output parameter based on the at least one transfer function using a primary display layer that presents a testbed environment for the business information and decisioning control system;
interpreting at least one of signals, trends, warning and conclusions generated by the stochastic simulation and presenting an interpretation of the at least one of signals, trends, warning and conclusions generated by the stochastic simulation using at least one secondary display layer;
displaying a plurality of suggested business decisions using a tertiary display layer, wherein the plurality of suggested business decisions developed based on the signals, trends, warning and conclusions generated by the primary display layer and the interpretation presented by the at least one secondary display layer.

2. A method as in claim 1, wherein each of the plurality of transfer functions mathematically or algorithmically describe a relationship between the plurality of input parameters and the at least one output parameter.

3. A method as in claim 1 further comprising disposing a visual cockpit to allow a user to interactively provide the plurality of input parameters and communicate with the primary display layer.

4. A method as in claim 3, wherein the visual cockpit comprises at least one of a graphical, textual or click-and-drag input mechanism to receive the plurality of input parameters from the user.

5. A method as in claim 3, wherein the visual cockpit is visually presented as a mask superimposed over the primary display layer.

6. A business system user interface of a business information and decisioning control system, wherein the business information and decisioning control system comprises a control module that is configured to receive information provided by multiple interrelated business processes in a business in relation to a plurality of input parameters associated with one or more of the resources used in the business and at least one output parameter associated with the operation of the business process and configured to generate a plurality of mathematical or algorithmic business system transfer functions, the user interface comprising:
a primary display layer that presents a testbed environment for the business information and decisioning control system, wherein the primary display layer is constructed as a stochastic simulation of the at least one output parameter based on the plurality of mathematical or algorithmic business system transfer functions;
at least one secondary display layer that presents interpretation of at least one of signals, trends, warning and conclusions generated by the primary display layer;
a tertiary display layer that presents a plurality of suggested business decisions developed based on the signals, trends, warning and conclusions generated by the primary display layer and the interpretation presented by the at least one secondary display layer.

7. A user interface as in claim 6, wherein each of the primary display layer, the at least one secondary display layer, tertiary display layer comprises at least one display zone having an adaptable visibility state of at least one of transparency, translucency or opaqueness.

8. A user interface as in claim 7, wherein the visibility state of the display zone is dependent on the activity taking place in that display zone.

9. A user interface as in claim 6, wherein each of the primary display layer, the at least one secondary display layer and the tertiary display layer further comprises a plurality of software agents to monitor and control the functioning of the respective display layer.

10. A user interface as in claim 9, wherein the plurality of software agents are layered between descriptive and prescriptive poles, deployed in accordance with at least one of a vertical stacking and a parallel processing method and configured to communicate with each other to enable the functioning of the respective display layer.

11. A user interface as in claim 6, wherein each of the plurality of transfer functions mathematically or algorithmically describe a relationship between the plurality of input parameters and the at least one output parameter.

12. A user interface as in claim 6, wherein the primary display layer is further configured to present the stochastic simulation substantially in real time.

13. A user interface as in claim 6, wherein the primary display layer is further configured to present an animation of the stochastic simulation.

14. A user interface as in claim 6 further comprising a visual cockpit to allow a user to interactively provide the plurality of input parameters and communicate with the test bed environment.

15. A user interface as in claim 14, wherein the visual cockpit is further configured to allow a user to interactively interrupt, execute and change the functioning of the primary display layer.

16. A user interface as in claim 14, wherein the visual cockpit comprises at least one of a graphical, textual or click-and-drag input mechanism to receive the plurality of input parameters from the user.

17. A user interface as in claim 14, wherein the visual cockpit is decoupled from the primary display layer.

18. A user interface as in claim 14, wherein the visual cockpit is visually presented as a mask superimposed over the primary display layer.

19. A user interface as in claim 18, wherein the mask comprises a plurality of interaction zones, wherein each of the interaction zones is configured to interlace with, correspond to and interact with at least one part of the primary display layer.

20. A user interface as in claim 19, wherein each of the interaction zones have an adaptable visibility state of at least one of transparency, translucency or opaqueness.

21. A user interface as in claim 20, wherein the visibility state of the interaction zone is dependent on the activity taking place in the interaction zone.

22. A user interface as in claim 6 further comprising a visual display of a response surface based on the plurality of input parameters, the at least one output parameter and the transfer function.

23. A user interface as in claim 6, wherein the business information and decisioning control system generates auto-piloted decisions.
